(19) United States
(12) Patent Application Publication
(10) Pub. No.: US 2012/0224490 A1
(43) Pub. Date: Sep. 6, 2012

(54) DEVICE AND METHOD FOR IDENTIFYING THE LOCATION OF ANOMALY LINK WITH LINK CANDIDATES REFINED BY MEANS OF THE NUMBER OF OVERLAPPING ABNORMAL FLOWS

(75) Inventor: Satoshi IKADA, Nara (JP)

(73) Assignee: OKI ELECTRIC INDUSTRY CO., LTD., Tokyo (JP)

(21) Appl. No.: 13/405,375

(22) Filed: Feb. 27, 2012

(30) Foreign Application Priority Data
Mar. 2, 2011 (JP) 2011-045518

(51) Int. Cl. H04L 12/26

(52) U.S. Cl. 370/242

(57) ABSTRACT

In an anomaly locating device, a flow information collector collects flow information on flows between terminal devices from observation nodes arranged at observation points over a telecommunications network, and an anomaly location narrow-downer counts, based on the flow information, the number of overlapping abnormal flows passing through each link connected to the observation points to determine a link having the largest number of overlapping abnormal flows from among the links connected to the observation points. The anomaly location narrow-downer then collects link candidates reachable by routing via the link thus determined. An anomaly link identifier narrows down the collected link candidates to an abnormal link.

### BACKGROUND OF THE INVENTION

1. Field of the Invention

The present invention relates to an anomaly locating device, and more particularly to an anomaly link locating device for observing links on a telecommunications network to locate an anomaly link. The present invention also relates to a method therefor.

2. Description of the Background Art

In recent years, there has been an increase of services to provide multimedia data, such as audio data and moving image data, in real time by using a streaming technique. As a consequence, a large amount of data is transmitted at high speeds over telecommunications networks. Real-time communications use communications protocols such as RTP (Real-time Transport Protocol) or RTCP (RTP Control Protocol).

RTP is a type of UDP (User Datagram Protocol) that fails to take measures against packet loss and has no transmission time assurance, and thus suitable for transmitting data in real time with a little delay. On the other hand, as RTP is susceptible to disturbance occurring on communication channels, there arises a problem that voice communication may be interrupted and images may be distorted, and thereby the quality of services for users may be degraded.

Therefore, in communication services provided to users on an IP (Internet Protocol) network, great importance has been attached to the quality of moving image data streaming and visual communications, such as video conference. In order to provide these services, the quality control of the communication service is required. In the quality control, it is superior to locate malfunctions on the network and take measures against malfunctions such as quality degradation.

In a data communication established between a user on an administrated network of an Internet service provider (ISP) or carrier (internal network) and a server or terminal device on another network administrated by another ISP or carrier (external network), when degradation in quality of service is detected on the communication and causes malfunction on the other, or external, network, it would be difficult to locate the malfunctioning point for an ISP or carrier which does not administrate the causative network unless information on the latter network is obtained. Such a case may involve a difficulty of failing to figure out a cause of the malfunction to conduct maintenance service.

In this way, communications across several networks administrated by different ISPs or carriers make it difficult to guarantee the quality of service to the users for the respective ISPs or carriers. Consequently, it is necessary to provide such communications with a mechanism to detect and locate a malfunctioning point.

As solutions to the above difficulty, methods for locating a malfunction on a network have been offered, in which a plurality of observation points are arranged on a network to observe data traffic flowing through the observation points, thereby detecting abnormal flows in which the quality of communication is degraded and then narrowing down the range of possible malfunctions to locate a malfunction by means of the detected abnormal flow along with topology and routing information of the network.

More specifically, such methods are disclosed, for instance, in United States patent application publication No. US 2006/0190620 A1 to Kobayashi, and in Masayoshi Kobayashi, et al., “Estimating Points of QoS Degradation in the Network from the Aggregation of Per-flow Quality Information”, Technical Report of the Institution of Electronics, Information and Communication Engineers (IEICE), TM-2004-107, pp. 31-36 (2005). These methods collect topology information of a network in advance, and use, when an observation point detects abnormal flows, the abnormal flow and the flow information to create a flow-quality/via-link table, i.e. flow link correspondence table, in which links where the abnormal flows pass are aggregated for each abnormal flow, and to which a technique called minimum-link number estimation method is then applied to identify the locations/links of fault or anomaly.

In the context, a data stream over a network between terminal devices may be regarded as a flow.

The method for determining the minimum number of links disclosed in the above documents is equivalent to solving a set cover problem. Therefore, when the size of a network expands so that the numbers of links and abnormal flows increase, a flow link correspondence table of large size has to be created for processing, thereby taking time to perform calculation because the set cover problem is generally known as one of problems which belong to the NP-hard (non-deterministic polynomial-time hard) class.

### SUMMARY OF THE INVENTION

It is an object of the present invention to provide an anomaly locating device and a method therefor, which can minimize the memory capacity required for and the operational burden taken for locating a malfunction.

According to the present invention, an anomaly locating device for use in a telecommunications network formed by a plurality of nodes connected by links conveying flows between terminal devices, wherein the plurality of nodes include an observation node arranged at an observation point, comprises: a flow information collector collecting flow information on the flows between the terminal devices from the observation node; an anomaly location narrow-downer counting an overlap number of overlapping abnormal flows passing through the link connected to the observation point on the basis of the flow information, and determining such one of the links connected to the observation point that is largest in the overlap number, the anomaly location narrow-downer collecting a link candidate reachable by routing via the one link determined; and an anomaly link identifier narrowing down the collected link candidates to locate an anomaly link malfunctioning, the anomaly location narrow-downer comprising: a counter counting the overlap number; a determiner determining the one link being largest in the overlap number; and a link candidate collector collecting a link candidate reachable by routing via the determined one link.

Also according to the present invention, a method for locating an anomaly link in a telecommunications network formed by a plurality of nodes connected by links conveying flows between terminal devices, wherein the plurality of nodes include an observation node arranged at an observation point, comprises: collecting flow information on the flows between the terminal devices from the observation nodes by a flow information collector collecting the flow information; counting based on the flow information an overlap number of overlapping abnormal flows passing through the links connected to the observation point by a counter of an anomaly location narrow-downer counting the overlap number of the abnormal flows; determining such one of the links connected to the observation point that is largest in the overlap number by a determiner of an anomaly location narrow-downer determining the one link; collecting a candidate reachable by routing via the determined one link by a link candidate collector of the anomaly location narrow-downer collecting the link candidate reachable; and narrowing down the collected link candidates to locate an anomaly link malfunctioning by an anomaly link identifier locating the anomaly link.

Further in accordance with the present invention, there is provided a program for use in a telecommunications network formed by a plurality of nodes connected by links conveying flows between terminal devices, wherein the plurality of nodes include an observation node arranged at an observation point, the program causing a computer, in which the program is installed and run, to serve as the anomaly locating device as described above.

Furthermore, in accordance with the present invention, an anomaly identifying system in a telecommunications network formed by a plurality of nodes connected by links conveying flows between terminal devices comprises: an observation node included in the plurality of nodes and arranged at an observation point; and the anomaly locating device described above and adapted to be supplied with flow information on the flows observed at the observation node.

In accordance with the present invention, the flow information collector collects information on flows between terminal devices from the observation nodes arranged at the observation points on a telecommunications network. The anomaly location narrow-downer includes the determiner and the link candidate collector. The anomaly location narrow-downer counts the number of overlapping abnormal flows passing through the links connected to the observation points on the basis of the flow information. The determiner determines a link having the largest number of overlapping abnormal flows among the links connected to the observation points. The link candidate collector collects a link candidate reachable by routing via the link thus determined. The anomaly link identifier narrows down the collected link candidates to locate one or more anomaly links malfunctioning. This procedure offers advantages in minimizing the memory capacity and operation burden for locating one or more malfunctions.

### BRIEF DESCRIPTION OF THE DRAWINGS

The objects and features of the present invention will become more apparent from consideration of the following detailed description taken in conj unction with the accompanying drawings in which:

FIG. 1 shows a schematic network connection of a preferred embodiment of anomaly identifying system to which applied is an anomaly locating device in accordance with the present invention;

FIG. 2 is a block diagram schematically showing the configuration of an observation node shown in FIG. 1;

FIG. 3 shows internal and external abnormal flows in the anomaly identifying system shown in FIG. 1;

FIG. 4 shows, like FIG. 3, internal and external normal flows in the anomaly identifying system;

FIG. 5 shows flow information supplied by the observation node 16a to an anomaly locating device shown in FIG. 1;

FIG. 6 shows, like FIG. 5, flow information supplied by another observation node 16b shown in FIG. 1 to the anomaly locating device;

FIG. 7 shows, like FIG. 5, flow information supplied by yet another observation node 16c shown in FIG. 1 to the anomaly locating device;

FIG. 8 is a block diagram schematically showing the configuration of the anomaly locating device shown in FIG. 1;

FIG. 9 is a block diagram schematically showing the configuration of an anomaly location narrow-downer shown in FIG. 8;

FIG. 10 is an operational flowchart useful for understanding operation steps of the anomaly locating device shown in FIG. 8;

FIG. 11 is an operational flowchart useful for understanding a procedure of overlap calculation on abnormal flows in the operational flow shown in FIG. 10;

FIG. 12 shows the network connection shown in FIG. 1 together with the number of overlapping internal abnormal flows on links connected to the observation point 16a in the network shown in FIG. 1;

FIG. 13 shows, like FIG. 12, the network connection together with the number of overlapping external abnormal flows on the links connected to the observation point 16a;

FIG. 14 shows, also like FIG. 12, the network connection useful for understanding subtraction processing performed on the number of overlapping internal abnormal flows on the links connected to the observation point 16a;

FIG. 15 shows, like FIG. 14, the network connection useful for understanding subtraction processing performed on the number of overlapping external abnormal flows on the links connected to the observation point 16a;

FIG. 16 shows, like FIG. 14, the network connection useful for understanding subtraction processing performed on the number of overlapping external abnormal flows on the links located between the observation points, where the normal flows pass, in the network shown in FIG. 1;

FIG. 17 shows a result of aggregation of the numbers of overlapping internal and external abnormal flows over the network;

FIG. 18 shows a flow link correspondence table created for the flows conducted across the network;

FIG. 19 shows, like FIG. 18, another flow link correspondence table temporarily created for the flows conducted across the network;

FIG. 20 shows, like FIG. 18, yet another flow link correspondence table created eventually for the flows conducted across the network;

FIG. 21 shows a schematic network connection of an alternative embodiment of anomaly identifying system to which applied is an anomaly locating device of the present invention;

FIG. 22 schematically shows an example of flows across the network shown in FIG. 21;

FIG. 23 shows flow information supplied by the observation node 16a to an anomaly locating device in the network shown in FIG. 21;

FIG. 24 shows, like FIG. 23, flow information supplied by the observation node 16b to the anomaly locating device shown in FIG. 21;

FIG. 25 shows, like FIG. 23, flow information supplied by the observation node 16c to the anomaly locating device shown in FIG. 21;

FIG. 26 is a block diagram schematically showing the configuration of an anomaly location narrow-downer included in the anomaly locating device shown in FIG. 21;

FIG. 27 is an operational flowchart useful for understanding operation steps of the anomaly locating device shown in FIG. 21;

FIG. 28 shows the network connection shown in FIG. 21 together with the numbers of overlapping abnormal flows on links connected to three observation nodes in the network shown in FIG. 21;

FIG. 29 shows a flow link correspondence table to be stored in a link candidate memory in the network shown in FIG. 21; and

FIG. 30 shows the results of anomaly link identification performed by aggregating the flow link correspondence table shown in FIG. 29.

### DESCRIPTION OF THE PREFERRED EMBODIMENTS

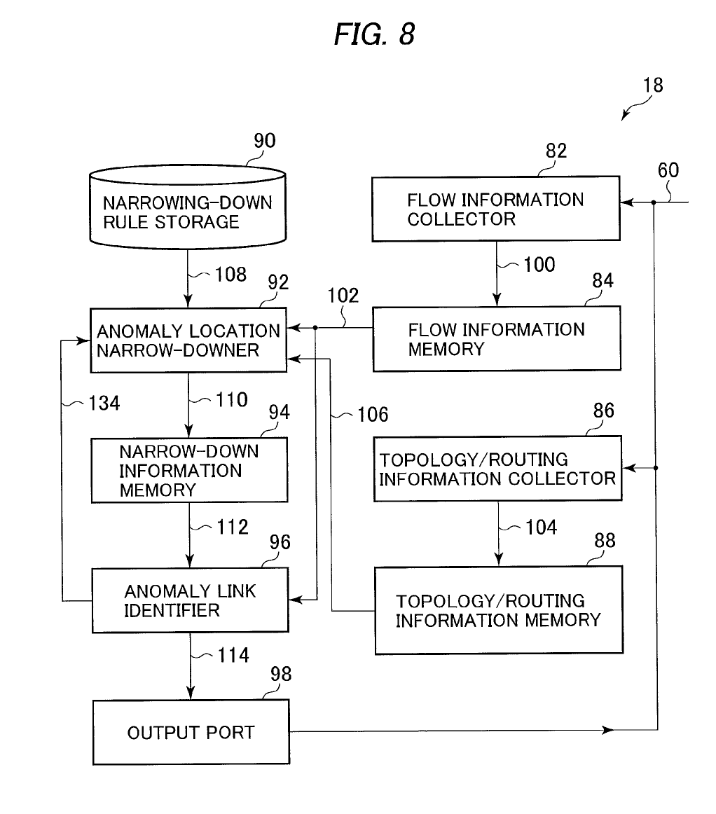

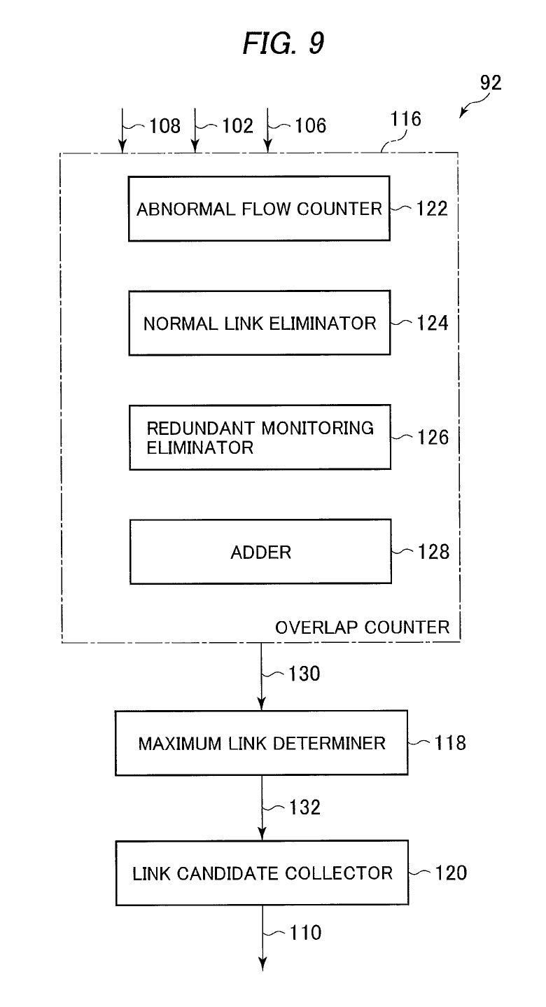

With reference to the accompanying drawings, a preferred embodiment of anomaly locating device of the present invention will be described in detail. At first, reference will be made to FIG. 8, which shows an illustrative embodiment of anomaly locating device 18 to which applied is the anomaly locating device of the invention. The anomaly locating device 18 is so adapted that a flow information collector 82 collects information on flows between terminal devices from an observation node, such as router, allocated at an observation point on a telecommunications network, the flow information being used by an anomaly location narrow-downer 92 to count the number of overlapping abnormal flows passing over links connected to the observation point, the anomaly location narrow-downer 92 including a maximum link determiner adapted to determine such one of the links connected to the observation points that has the largest number of overlapping abnormal flows, the anomaly location narrow-downer 92 including a link candidate collector adapted to collect link candidates which are reachable by routing via the one link thus determined, an anomaly link identifier 96 narrowing down the collected link candidates to a malfunctioning link, whereby the memory capacity and operational burden for locating one or more malfunctions or anomalies can be minimized. In addition, as shown in FIG. 9, the anomaly location narrow-downer 92 is adapted to count the overlap of abnormal flow by an overlap counter 116, determine a link having the largest number of overlapping abnormal flows by a maximum link determiner 118, and collect link candidates reachable by routing, via the link thus detected, by means of a link candidate collector 120. The number of overlapping flows, such as abnormal flows, i.e. multiplicity of flows, may preferably be one observed in a time period of interest. The number of overlapping flows may be observed in a unit period of time. In the latter case, the number of overlapping flows may be referred to as the frequency or ratio of overlapping flows.

Elements irrelevant to understanding the present invention will not be illustrated or described herein. In addition, signals are indicated with reference numerals allotted to connecting lines on which the signals are present. Like constituent elements may be assigned to the same reference numerals and repetitive descriptions thereon will be avoided.

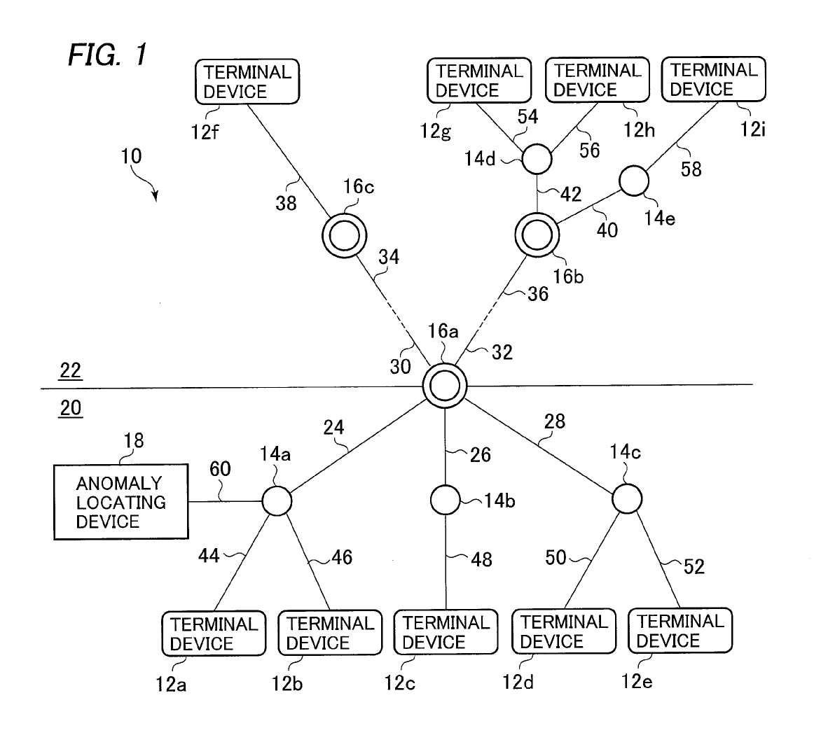

Now, with reference to FIG. 1, a description will be made on the schematic configuration of an anomaly identifying system 10 according to an illustrative embodiment of the present invention. The anomaly identifying system 10 includes, as shown in FIG. 1, terminal devices 12a to 12i, telecommunications nodes, such as routers, 14a to 14e, observation nodes 16a to 16c and the anomaly locating device 18. The routers 14a to 14e may be referred to as switches. These constituent elements are interconnected by links 20a to 20t as depicted. The numbers of those components are merely illustrative.

The terminal devices 12a to 12i have a user interface function for allowing the user to input and receive data. The terminal devices 12a to 12i may be intelligent or dedicated terminal units having functions, such as text data edit or printing function. In order to implement such processing and functions, the terminal devices may have hardware, such as a CPU (Central Processing Unit), ROM (Read Only Memory), RAM (Random Access Memory), a hard disk drive, a communication facility, a display unit and a machine interface, e.g. keyboard or pointing device. In this configuration, the CPU operates under programs stored in the ROM so as to carryout, for instance, various processes for providing the user with information obtained from the routers 14a to 14e.

The router 14a to 14e are adapted to establish interconnections on telecommunications networks and have a function of controlling connections, information transfers, information selection and state monitoring. The routers 14a to 14e may be interconnected by the links to the terminal devices 12a to 12i and also to the observation nodes 16a and 16b.

The observation nodes 16a, 16b and 16c, which may be routers, are located at observation points on some of the networks and have a function of monitoring data traffic passing through the observation points to supply the anomaly locating device 18 with flow information resulting from the traffic monitoring. The flow information means information on a packet flow of communication, which includes, for example, information on applications and source and destination IP (Internet Protocol) addresses. The observation nodes 16a to 16c can be arranged at gateways of small networks, e.g. autonomous systems (ASs) or Internet service providers (ISPs).

When focusing on one 16a of the observation nodes 16a, 16b and 16c shown in FIG. 1, a link or links over which the terminal devices 12a to 12e or the anomaly locating device 18 are reachable from the observation point of that observation node 16a without passing the observation points of the remaining observation nodes 16b and 16c are referred to as an internal network 20, whereas a link or links extending from the observation point of that observation node 16a to the observation points of the remaining nodes 16b and 16c and a link or links over which the terminal devices 12f to 12i are reachable via the observation points of the remaining nodes 16b and 16c are referred to as an external network 22.

As can be seen from FIG. 1, the illustrative embodiment is exemplarily focused on the observation point of the observation node 16a, in which routes from the observation node 16a to the router 14a, 14b and 14c in the internal network 20 are respectively defined as links 24, 26 and 28. In the external network 22, routes from the observation node 16a to the observation nodes 16b and 16c are respectively defined as links 30 and 32, which are on that observation node 16a side. Also, routes on the observation node 16c side and the node 16b side, which are respective, direct extensions of the links 30 and 32, are respectively defined as links 34 and 36. The observation node 16c is further connected to the terminal device 12f by a link 38, while the observation node 16b is connected to the routers 14e and 14d by links 40 and 42, respectively.

In the internal network 20, the router 14a is connected to the terminal devices 12a and 12b respectively by links 44 and 46, and the router 14b is connected to the terminal device 12c by a link 48. The router 14c is connected to the terminal devices 12d and 12e respectively by links 50 and 52. As to the external network 22, the router 14d is connected to the terminal devices 12g and 12h by links 54 and 56, respectively. Further, the router 14e is connected to the terminal device 12i by a link 58. The router 14a is also connected to the anomaly locating device 18 by a link 60.

In this embodiment, a data flow passing inside the internal network 20 between the terminal devices 12a to 12e is called as internal flow, while a data flow passing between the terminal devices 12f to 12i within the external network 22 is called as external flow.

The anomaly locating device 18 has a function of gathering flow information from the observation nodes 16a, 16b and 16c to use the gathered information for narrowing down possible anomalous links on the network so as to locate, or identify the location of, one or more anomaly links. Further details thereon will be described later. It is important with the illustrative embodiment to note that the anomaly locating device 18 is adapted to narrow down the range or extent of locating anomalies before determining an anomaly link or links, thereby allowing the memory capacity and operational burden for identifying anomaly links to be minimized.

The illustrative embodiment shown in FIG. 1 has the anomaly locating device 18 connected to the router 14a, but it is not limited to this embodiment where the anomaly locating device 18 is connected. Although the anomaly locating device 18 is formed as an independent unit in the embodiment, the functions of the device 18 can be incorporated in any of the observation nodes 16a to 16c, the router 14a to 14e or the terminal devices 12a to 12i.

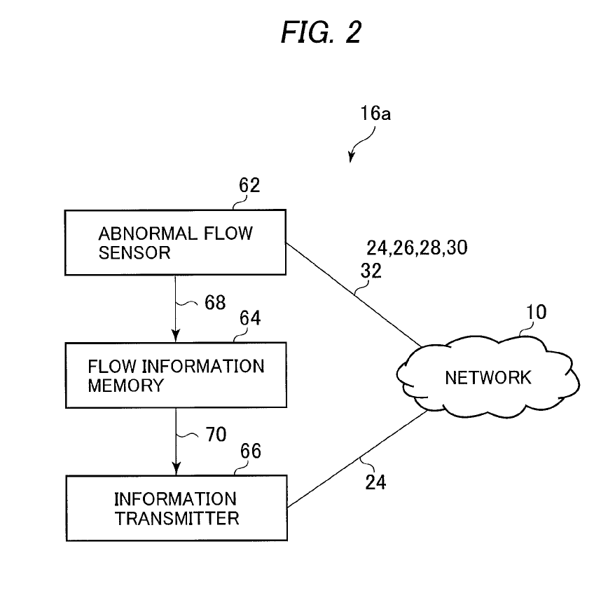

Now, the schematic configurations of the observation nodes 16a, 16b and 16c will be described by referring to FIG. 2. As the observation nodes 16a to 16c may have the similar constituent elements to each other, FIG. 2 illustrates the configuration of the node 16a as a representative. The observation node 16a includes an abnormal flow sensor 62, a flow information memory 64 and an information transmitter 66, which are interconnected as shown.

The abnormal flow sensor 62 has a function of monitoring the flows over the network 10 to detect an abnormal flow degraded in quality. In the observation node 16a, the abnormal flow sensor 62 monitors flows passing over the links 24, 26, 28, and 32. The abnormal flow sensor 62 may be adapted to perform statistical processing on the values of packet loss rate, transmission delay and fluctuation in delay of flows, by way of example, so as to determine an abnormal flow when a value resultant from the statistical processing exceeds a predetermined threshold. Alternatively or additionally to that, the abnormal flow sensor 62 may be adapted to obtain an R-value as an evaluation index according to ITU-T (International Telecommunication Union-Telecommunication standardization sector) Recommendation G.107 to detect an abnormal flow. The abnormal flow sensor 62 supplies the flow information memory 64 with information 68 obtained by monitoring over a given period, e.g. flow information on an abnormal and a normal flow.

The flow information memory 64 has a function of storing the information 68 obtained by monitoring over the given period, e.g. the flow information about the abnormal and normal flows. Preferably, the flow information can identify a series of traffic conveyed over the network 10 when the user is enjoying a service on a terminal device. For example, the flow information may include the type of flow indicative of abnormal or normal state, source and destination addresses, protocol type, and source and destination port numbers, and further may include the input interface and the type of service. The flow information memory 64 outputs flow information 70 read out therefrom to the information transmitter 66.

The information transmitter 66 has a function of transmitting the stored flow information to the anomaly locating device 18. The information transmitter 66 may be connected to transmit the flow information over the network 10 or a dedicated line. The transmitter 66 supplies the flow information 70 to the anomaly locating device 18 via the link 24, the router 14a and the link 60, in this order.

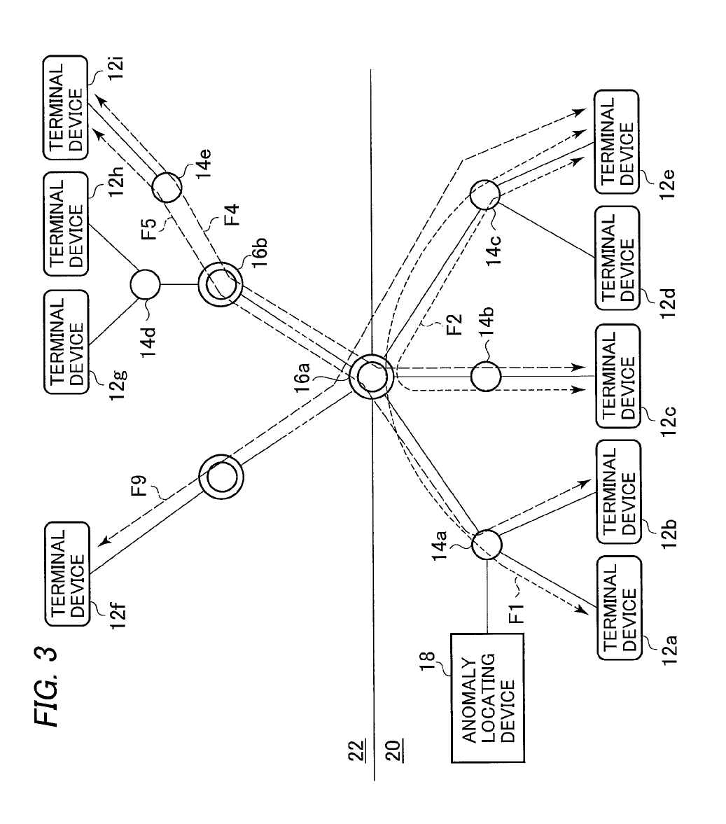

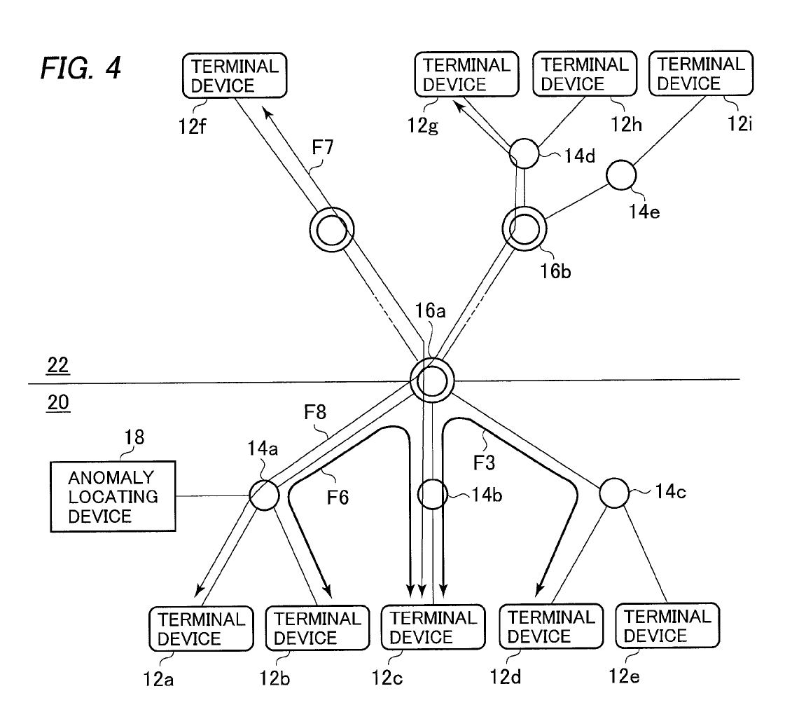

With reference to FIGS. 3 and 4, a description will be made on a specific example of the flow information transmitted from the observation nodes 16a, 16b and 16c to the anomaly locating device 18 in the anomaly identifying system 10. As an example, attention is directed to data flows F1 through F9, which may be classified into the internal and external flows as described before. Both of the internal and external flows may include abnormal and normal flows. From the viewpoint of the abnormal and normal flows, FIG. 3 illustrates the internal and external abnormal flows across the network and FIG. 4 illustrates the internal and external normal flows across the network.

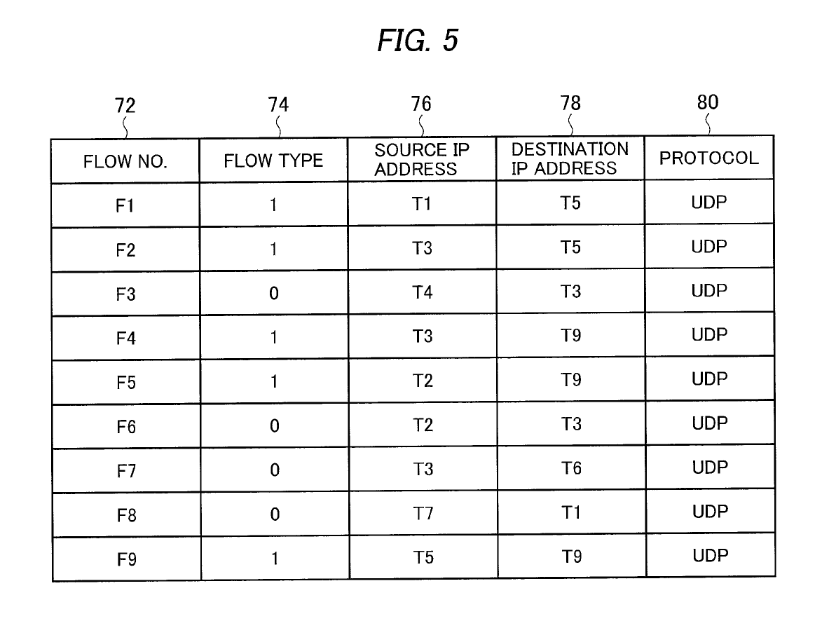

FIG. 3 indicates the internal abnormal flows F1 and F2 by thin dotted lines with arrows while indicating the external abnormal flows F4, F5 and F9 by thin dashed lines with arrows. Similarly, FIG. 4 indicates the internal normal flows F3 and F6 by thick solid lines with arrows while indicating the external normal flows F7 and F8 by thin solid lines with arrows. In these cases, the observation nodes 16a, 16b and 16c direct the flow information shown in FIGS. 5, 6 and 7 to the anomaly locating device 18.

The flow information illustrated in FIGS. 5, 6 and 7 includes items defined as a flow number 72, a flow type 74, a source IP address 76, a destination IP address 78 and a protocol type 80. The flow number 72 specifies the data flows F1 to F9, but is not particularly necessary because this item is provided merely in order to identify which line of the table represents which flow. The flow type 74 may be a flag or numerical value for sorting out the flows into a value “1” as an abnormal flow and a value “0” as a normal flow. With regard to the items of source and destination IP addresses, the terminal devices 12a to 12i are respectively assigned with IP addresses T1 to T9 as identifications specific thereto. In practice, an IP address consists of four sets of numbers separated by dots, such as “192.168.0.8”. The source IP address 76 and the destination IP address 78 indicate the direction of flow information transmitted. The protocol type 80 is dedicated to define rules for handling packets to be transmitted.

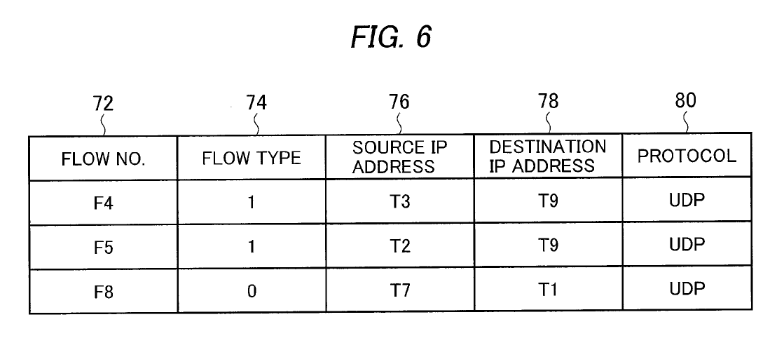

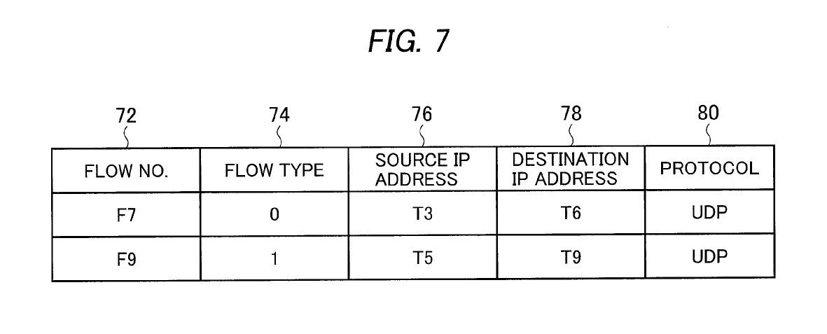

FIG. 5 shows flow information on the flows F1 to F9 which the observation node 16a passes and monitors at its observation point to send the flow information to the anomaly locating device 18. Also, the observation node 16b monitors the flows F4, F5 and F8 passing through its observation point as shown in FIG. 6 to send the flow information on the flows F4, F5 and F8 to the anomaly locating device 18. Correspondingly, as shown in FIG. 7, the observation node 16c monitors the flows F7 and F9 to send the flow information on the flows F7 and F9 to the anomaly locating device 18.

The anomaly locating device 18 includes, as shown in FIG. 8, a flow information collector 82, a flow information memory 84, a topology/routing information collector 86, a topology/routing information memory 88, a narrowing-down rule storage 90, an anomaly location narrow-downer 92, a narrow-down information memory 94, an anomaly link identifier 96 and an output port 98, which are interconnected as illustrated.

The flow information collector 82 has a function of collecting the flow information 60 sent from the observation nodes 16a, 16b and 16c. The flow information collector 82 receives the flow information 60 supplied through the router 14a connected to the network, and then outputs the collected flow information 60 as flow information 100 to the flow information memory 84. The flow information memory 84 has a function of temporarily storing the flow information 100 in the form of flow information 102 from which a source observation node can be identified. The memory 84 then supplies the temporarily stored flow information 102 to the anomaly location narrow-downer 92.

The topology/routing information collector 86 has a function of collecting information on routing and topology from the network. The topology/routing information collector 86 may be adapted to gather, for instance, packets of routing protocol, such as BGP (Border Gateway Protocol), running over the network. Alternatively or additionally, the information collector 86 may be adapted to use SNMP (Simple Network Management Protocol) or the like to gather information from the routers 14. The information collector 86 receives the flow information 60 supplied through the router 14a connected to the network to collect information on the routing and topology. The collector 86 then outputs topology/routing information 104 thus collected to the topology/routing information memory 88.

The topology/routing information memory 88 is adapted to temporarily store the collected topology/routing information 104 and output the temporarily stored topology/routing information 104 to the anomaly location narrow-downer 92.

The topology/routing information memory 88 may have a function of referencing source and destination IP addresses to search for such one of the links conveying communications between two points or of the links connected to a router that is reachable by routing.

The narrowing-down rule storage 90 has a function of storing limitation or refining rules for use in narrowing down, or refining, link candidates included in a range or extent intended for identifying an anomaly link with the flow information and the topology/routing information. The narrowing-down rule storage 90 receives and stores the rules for limitation, not shown, and then develops the narrowing-down rules 108 thus stored to the anomaly location narrow-downer 92.

The anomaly location narrow-downer 92 has a function of referring to the flow information 102 and the topology/routing information 106 to apply appropriate one of the narrowing-down rules 108 to thereby narrow down, or refine, the link candidates in the range intended for the anomaly link identification. The anomaly location narrow-downer 92 conducts identification to refiningly select a link candidate 110 among the links included in the intended range and outputs information on the link candidate 110 to the narrow-down information memory 94. A configuration example of the anomaly location narrow-downer 92 will be described later in detail by referring to FIG. 9.

The narrow-down information memory 94 is adapted for storing information on the narrowed-down link candidates to supply link candidate information 112 to the anomaly link identifier 96.

The anomaly link identifier 96 has a function of narrowing down the candidates to an anomaly link based on the stored link candidate information 112 and flow information 102. The anomaly link identifier 96 may be adapted to create a flow link correspondence table, as disclosed by Masayoshi Kobayashi, et al., described earlier, for the link candidate 112 thus refined, to use the flow link correspondence table to narrow down the range for locating anomaly links according to the method for identifying the minimum number of links. The anomaly link identifier 96 then sends to the output port 98 an anomaly link 114 thus narrowed down to.

The output port 98 has a function of outputting abnormality information 60 representing the anomaly link narrowed down to on the network. When an anomaly link is narrowed down to, the output port 98 may supply the abnormality information 60 to any of the corresponding observation nodes 16a, 16b and 16c. The output port 98 can be a visual display unit or printer.

Now, the configuration of the anomaly location narrow-downer 92 will be described with reference to FIG. 9. As shown in the figure, the anomaly location narrow-downer 92 includes an overlap counter 116, a maximum link determiner 118 and a link candidate collector 120, which are interconnected as depicted.

The overlap counter 116 is adapted to count the number of internal abnormal flows passing over the links connected to the observation points and the number of external abnormal flows passing over the links connected to the observation points separately from each other to produce the respective, numbers of overlapping internal and external abnormal flows. The overlap counter 116 may redundantly count normal flows as abnormal flows when it determines that a flow of interest meets any of conditions that a specific normal flow is detected, as described later. Therefore, the overlap counter 116 is adapted to measure the number of abnormal flows conveyed over a network system to be observed in the following fashion. Subtraction of the overlap number, or multiplicity, is performed depending on the number of normal flows to thereby establish internal and external abnormal flows. Then, in accordance with external normal flows narrowed down to as passing through between the same observation points as the external abnormal flows, the external abnormal flows passing through the observation nodes are dealt with as overlapping external normal flows, and thus a value corresponding to the number of those external abnormal flows is subtracted from the overlap numbers on the links between those observation points. The numbers of overlapping internal and external abnormal flows thus obtained from the subtraction are in turn summed up. In order to accomplish the above processes, the overlap counter 116 includes, as shown in FIG. 9, an overlapping-abnormal flow counter 122, a normal link eliminator 124, a redundant monitoring eliminator 126 and an adder 128.

More specifically, the overlapping-abnormal flow counter 122 is configured to count the number of abnormal flows passing over the links connected to the observation nodes as the number, e.g. frequency, of overlapping abnormal flows. The counter 122 is supplied with the flow information 102 and the topology/routing information 106 so as to collect information on the normality/abnormality of the information conveyed across the links. The counter 122 then counts up the abnormal flows passing over the links during a prescribed period, for instance, to store in the normal link eliminator 124 the number of overlapping abnormal flows calculated for each link, specifically the respective counts of the internal and external abnormal flows.

The normal link eliminator 124 has a function of eliminating normal flows as overlapping flows depending on the specific normal flows detected in order to establish abnormal flows. In the context, the specific normal flows are defined as an internal normal flow output fromat least one of the terminal devices which passes an abnormal flow of interest and as an external normal flow output from at least one of the terminal devices which passes an abnormal flow of interest.

The normal link eliminator 124 checks a couple of conditions for subtraction of the number of overlapping normal flows so as to eliminate one or ones corresponding to a normal flow or flows from abnormal flows. If first one of the conditions for subtracting the number of normal flows is satisfied where an internal normal flow is detected as coming from at least one of the terminal devices which passes an abnormal flow of interest, then the normal link eliminator 124 subtracts from the number of overlapping abnormal flows counted on the links connected to the at least one terminal device the number of overlapping abnormal flows output from the at least one terminal device, i.e. the number of normal flows. If second one of the conditions for subtracting the number of normal flows is satisfied where an external normal flow is detected as coming from at least one of the terminal devices which passes an abnormal flow of interest, then the normal link eliminator 124 subtracts flows corresponding to the number of abnormal flows output from the at least one terminal device, as the number of overlapping normal flows, from the number of overlapping abnormal flows counted on external normal flow links which are connected to all the observation points passing the external normal flow except the links on the side of the internal network containing the other of the terminal devices involved in the abnormal flow of interest. The eliminator 124 then supplies the obtained value as the overlap number to the adder 128.

The redundant monitoring eliminator 126 is configured to perform the subtraction of the overlap number of overlapping normal flows in such a way that, when an external normal flow passing through the same observation points as an external abnormal flow exists, an external abnormal flow passing through those observation points is dealt with as an external normal flow so as to be subtracted from the overlap number, or multiplicity, of a link which is located between the observation points and is monitored for appropriately appreciating the overlap number of anomaly links located between the observation points. In that case, the redundant monitoring eliminator 126 subtracts the number of external abnormal flows passing through the observation points from the overlap number of the link located between the observation points. The redundant monitoring eliminator 126 then supplies the obtained value as an overlap number to the adder 128.

The adder 128 has a function of aggregating the overlap number thus obtained. Specifically, the adder 128 aggregates or adds up the numbers of the overlapping internal abnormal flows and the numbers of the overlapping external abnormal flows to each other. The number 130 of overlapping abnormal flows counted by the overlap counter 116 is transferred to the maximum link determiner 118.

The maximum link determiner 118 has a function of determining a link having the largest one of the aggregated numbers of overlapping abnormal flows of the respective links. The maximum link determiner 118 refers to the counted number 130 of overlapping abnormal flows to determine a link presenting the largest one of the aggregated numbers of overlapping abnormal flows. Such a link thus determined may be referred to as a maximum link. Then, the determiner 118 sends information on the maximum link 132 thus determined to the link candidate collector 120.

The link candidate collector 120 is adapted to select as a link candidate a link located on the terminal device side and passing the abnormal flows that pass over the link determined as largest in aggregated overlap number, and output information on the selected link candidate 110 to the narrow-down information memory 94.

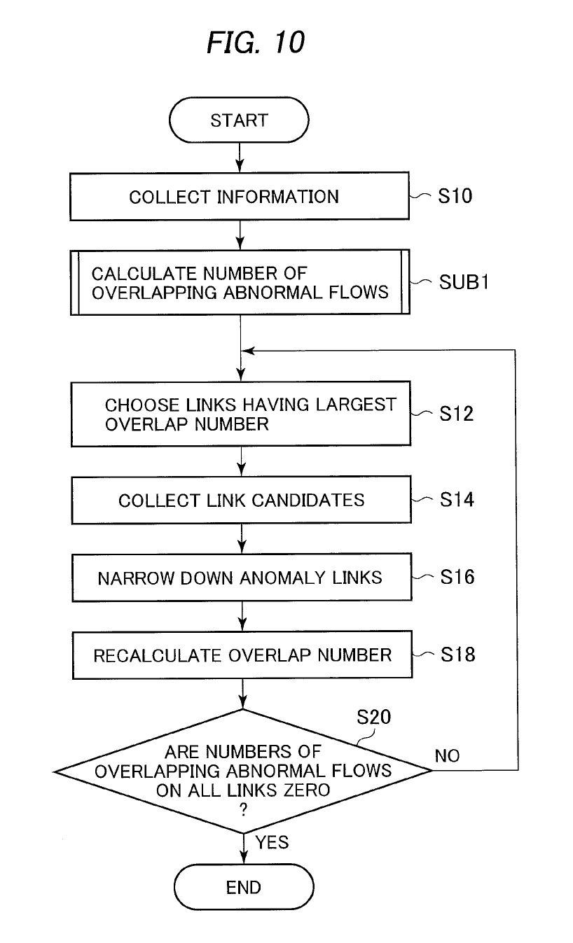

Next, the operation of the anomaly locating device 18 will be described by referring to FIG. 10. The anomaly locating device 18 collects flow information and topology/routing information (step S10). Flow information is collected by means of the flow information collector 82 and the flow information memory 84 to be transferred to the anomaly location narrow-downer 92. Topology/routing information is collected by means of the topology/routing information collector 86 and the topology/routing information memory 88 to be sent also to the anomaly location narrow-downer 92.

Then, the operation proceeds to subroutine SUB1 to calculate the number of overlapping abnormal flows. Briefly, the anomaly location narrow-downer 92 counts internal and external abnormal flows for each link. If any of the specific normal flows is detected, the anomaly location narrow-downer 92 then eliminates the abnormal flow as a normal flow from the count. Correspondingly, if any external normal flows are detected which pass through the same observation points as the external abnormal flows, the external abnormal flows are eliminated from the count as normal flows. The numbers of overlapping internal and external abnormal flows thus obtained by eliminating the normal flows will in turn be aggregated. Further details will be described later on.

In the following step S12, the maximum link determiner 118 of the anomaly location narrow-downer 92 chooses a link that has the largest one of the aggregated numbers of overlapping abnormal flows for the respective links. The maximum link determiner 118 sorts the overlap numbers of all links in the descending order in value to thereby choose the largest value. The determiner 118 then supplies information on the maximum link 132 thus chosen to the link candidate collector 120.

In step S14, the information gathering on link candidates proceeds in such a way that links across which abnormal flows pass from the link having the chosen overlap number toward a terminal device of interest are determined as link candidates or data on the terminal device side. The link candidate collector 120 outputs information on the collected link candidates or data as information on link candidates 110 to the narrow-down information memory 94. Also, the collector 120 writes, into a flow link correspondence table, information about such a link candidate on the terminal device side that passes abnormal flows passing over the link on which the number of overlapping abnormal flows is determined as largest.

The anomaly link identifier 96 in turn narrows down possible anomaly links to an anomaly link (step S16). For the identification, the anomaly link identifier 96 produces a flow link correspondence table based on the collected link candidates. The identifier 96 references the narrow-down information memory 94 which stores the produced flow link correspondence table to determine whether or not information on a link conveying an abnormal flow having the second largest or more overlap number is stored, thereby narrowing down the range of locating anomaly links to determine an anomaly link. When information on such a link is determined as stored, the identifier 96 sets an anomaly link flag 134 to a binary value “1”, by way of example, so as to determine the link as a location of abnormal quality. After the determination, the operation goes on to step S18 to recalculate or update the overlap numbers. If the anomaly link identifier 96 fails to find information on a link passing an abnormal flow being second largest or more in overlap number in the memory 94, the identifier 96 sets the anomaly link flag 134 to a binary value “0”, in this example. The operation correspondingly proceeds to step S18 to update the overlap number.

In step S18, the overlap number is calculated again. When the anomaly link flag 134 is set to “1”, the overlap counter 116 eliminates the link candidate, thus narrowed down to an anomaly link, from the flow link correspondence table in the narrow-down information memory 94 to subtract the number of the eliminated abnormal flows from the number of overlapping abnormal flows on the largest link chosen by the maximum link determiner 118. In addition, the overlap counter 116 subtracts the number of passing abnormal flows from the number of overlapping abnormal flows on a link connected to the other of the observation points which forwards abnormal flows passing on the candidate link narrowed down to the anomaly link.

When the anomaly link flag 134 is set to “0”, the overlap counter 116 refers to the flow link correspondence table stored in the narrow-down information memory 94, and subtracts the number of flows passing over one of the links which conveys the largest amount of abnormal flows listed in the table from the number of overlapping abnormal flows on the link chosen by the maximum link determiner 118, applying the number of passing flows to update the number of overlapping abnormal flows on the above chosen link.

Then, determination is made on whether or not the number of overlapping abnormal flows, of the entire links connected to the observation points is zero (step S20). Whenever the determination result is “true”, or YES, it is considered that the minimum number of links can be determined, and consequently a series of processes in the operation will be terminated. Correspondingly, whenever the result is “false”, or NO, the determination of the minimum number of links is not completed, and the determination will be repeated until a result indicating “YES” comes off.

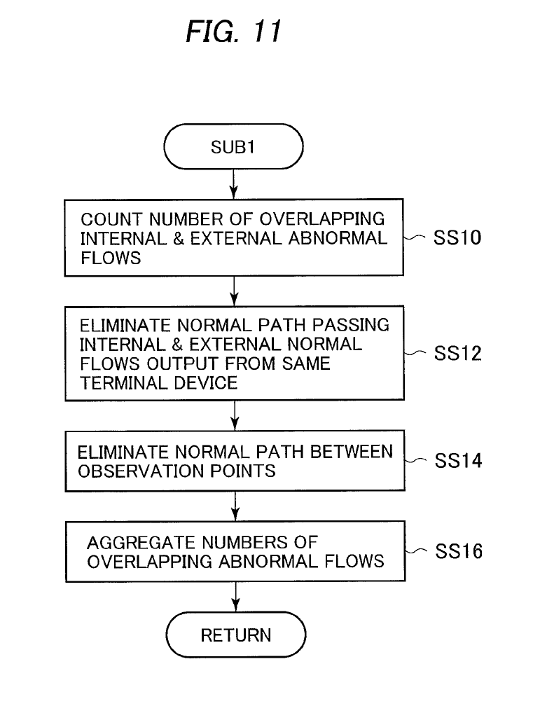

Next, the subroutine SUB1 of counting the number of overlapping abnormal flows will briefly be described with reference to FIG. 11. In this process, the abnormal flow counter 122 counts the number of internal abnormal flows passing over the links connected to the observation points, i.e. the number of overlapping internal abnormal flows, as well as the number of external abnormal flows, i.e. overlap number, passing over the links connected to the observation points (sub-step SS10).

Then, when a normal flow or flows are detected in either of two cases, the first case where there is detected an internal normal flow output from a terminal device from which an abnormal flow of interest comes out, or the second case where there is detected an external normal flow output from a terminal device from which an abnormal flow of interest comes out, the normal link eliminator 124 subtracts the number of normal flows from the number of overlapping either internal abnormal flows or external abnormal flows obtained by the counting process (sub-step SS12).

If there is detected an internal normal flow or flows output from a terminal device from which an abnormal flow of interest comes out, then the normal link eliminator 124 subtracts, as the number of normal flows, the number of abnormal flows output by that terminal device from the number of overlapping abnormal flows on the link on the terminal device side. If there is found an external normal flow or flows output from a terminal device from which an abnormal flow of interest comes out, the eliminator 124 subtracts, as the number of normal flows, the number of abnormal flows output by that terminal device from the number of overlapping abnormal flows counted on links which convey external normal flows at all the observation points passing the external normal flows except the links on the side of the internal network containing the other of the terminal devices involved in the abnormal flow of interest.

If there is found an external normal flow or flows passing between the same observation points as an abnormal flow of interest, the redundant monitoring eliminator 126 subtracts the number of external abnormal flows passing between those observation points, as the number of normal flows, from the overlap number of links located between the observation points (sub-step SS14).

The adder 128 aggregates the numbers of overlapping internal and external abnormal flows resultant from the subtraction of the flows corresponding to the number of normal flows (sub-step SS16). In this way, the overlap counter 116 calculates the number of overlapping abnormal flows.

In the following, an illustrative process in the anomaly locating device 18 will be described. This illustrative process is directed to the anomaly locating device 18 in the anomaly identifying system 10 when data flows are conveyed over the network as shown in FIGS. 3 and 4. Just for simplicity, the reference numerals are kept shown to the minimum in the figures.

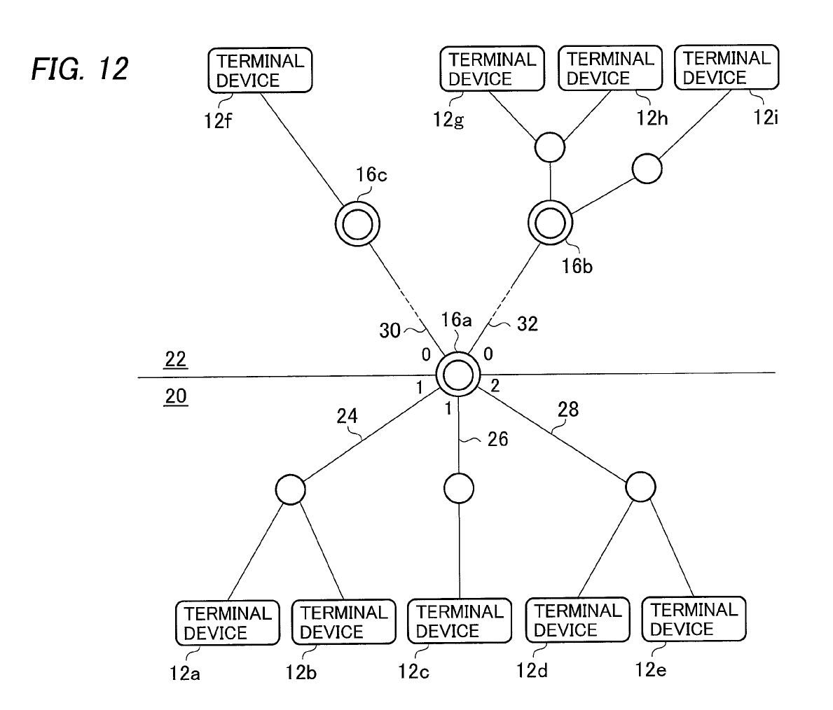

The abnormal flow counter 122 uses the flow information 102 supplied thereto to count, as shown in FIG. 12, the numbers of overlapping internal abnormal flows on the links connected to the observation point 16a. Over the link 28, for example, two internal abnormal flows F1 and F2 pass, as shown in FIG. 3, so that the abnormal flow counter 122 counts the number of the overlapping internal abnormal flows on the link 28 to a value of “2”. Further, the internal abnormal flow F1 runs over the link 24 while the internal abnormal flow F2 goes over the link 26, and no internal abnormal flows appear on the links 30 or 32, so that the counter 122 counts the number of overlapping internal abnormal flows on the links 24, 26, 30 and 32 to values of “1”, “1”, “0” and “0”, respectively.

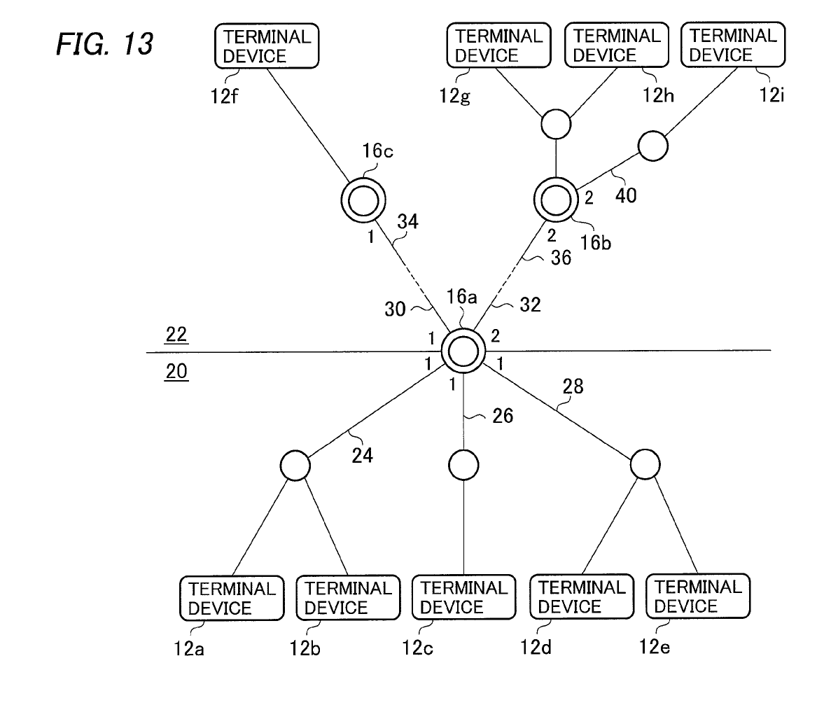

Similarly, the abnormal flow counter 122 uses the flow information 102 to count, as shown in FIG. 13, the numbers of overlapping external abnormal flows on the links connected to the observation point 16a. For instance, an external abnormal flow that passes over the link 30 is, as shown in FIG. 3, only the external abnormal flow F9, so that the counter 122 counts the number of overlapping external abnormal flow of the link 30 to a value of “1”. Since the links 24, 26 and 28 convey the external abnormal flows F5, F4 and F9, respectively, and the link 32 carries the external abnormal flows F4 and F5, the counter 122 counts the numbers of overlapping external abnormal flows on the links 24, 26, 28 and 32 respectively to values of “1”, “1”, “1” and “2”.

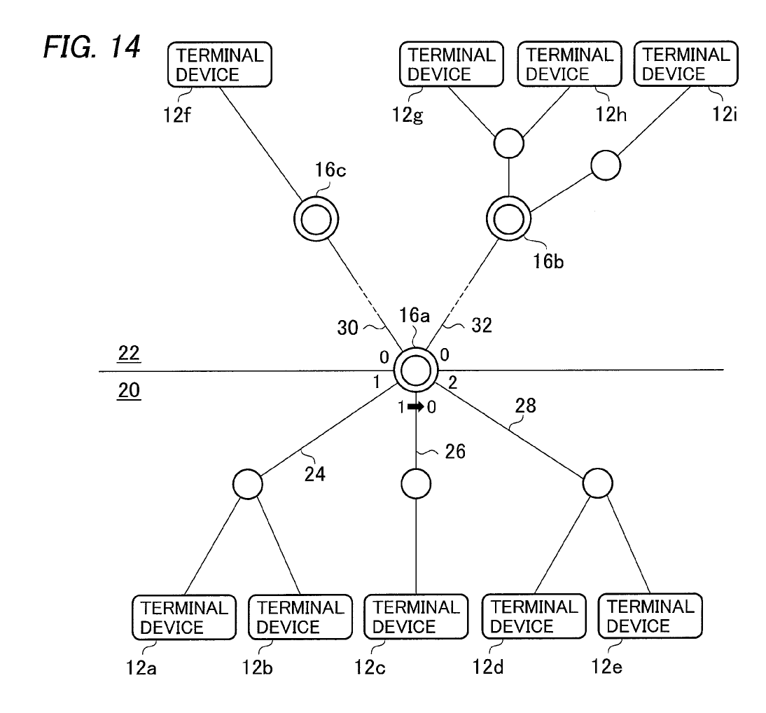

When there is found the internal normal flow F3, FIG. 4, which is output from the terminal device 12c which outputs the internal abnormal flow F2, FIG. 3, the normal link eliminator 124 subtracts the number of the passing abnormal flow, a value “1”, from the overlap number of the link 26 on the terminal device 12c side, a value “1”, in this example. The subtraction results in a value of “0”, as shown in FIG. 14, presenting the overlap number of the link 26 for the internal abnormal flows.

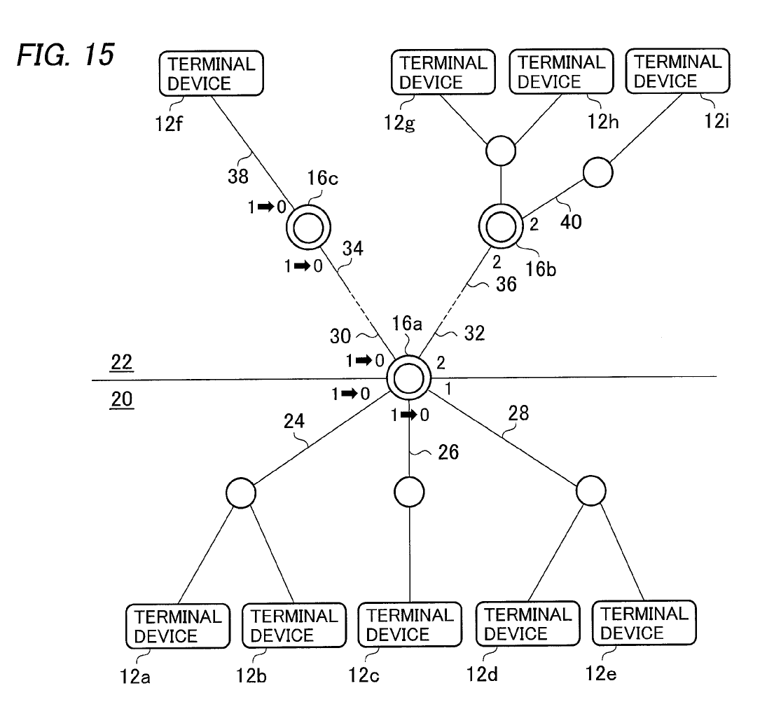

If there is detected the external normal flow F7, FIG. 4, which originates from the terminal device 12c which outputs the external abnormal flow F4, FIG. 3, then the normal link eliminator 124 subtracts the number of the passing abnormal flow, a value “1”, from the overlap number of the link 26, a value “1”, in this example, while excluding the link 32 on the side of the terminal device 12i which is the other of the terminal devices involved in the external abnormal flow F4. As a consequence, the overlap number of the link 26 for the external abnormal flow will become a value “0” as illustrated in FIG. 15.

Since the external abnormal flow F7 shown in FIG. 4 is also output from the terminal device 12f from which the external abnormal flow F9, FIG. 3, is output, the normal link eliminator 124 subtracts the number of passing abnormal flows, a value “1”, from the overlap number of each of the links 30, 34 and 38, a value “1”, while excluding the link 28 on the side of the terminal device 12e which is the other of the terminal devices involved in the external abnormal flow F9. Consequently, the overlap numbers of the links 30, 34 and 38 for the external abnormal flows become values “0” as illustrated in FIG. 15.

Furthermore, when there is detected the internal normal flow F6, FIG. 4, which starts from the terminal device 12b outputting the external abnormal flow F5 shown in FIG. 3, the normal link eliminator 124 subtracts the number of passing abnormal flows, a value “1”, from the overlap number of the link 24 on the side of that terminal device 12b, a value “1”. Thus, the overlap number of the link 24 for the external abnormal flows becomes a value “0” as shown in FIG. 15.

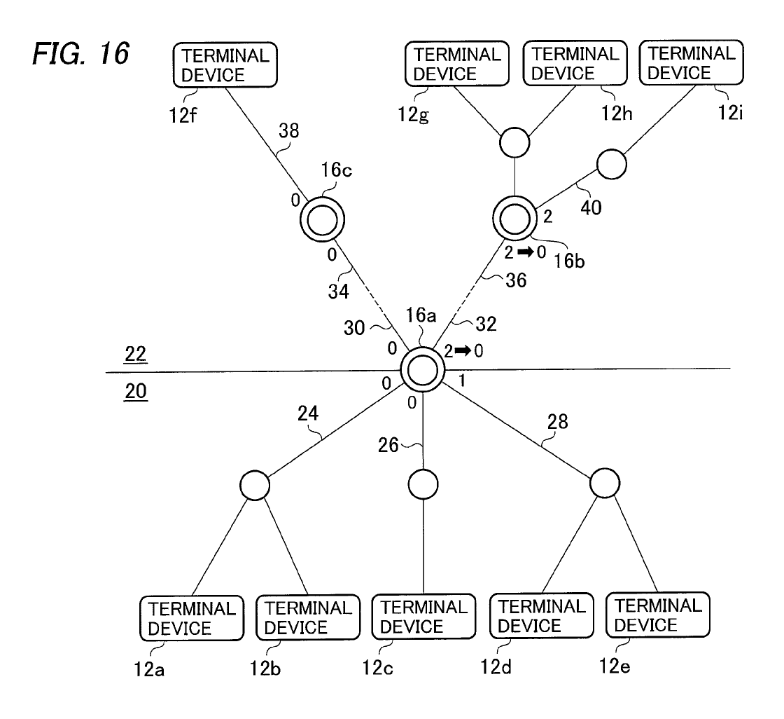

Then, in the case where the external normal flow passing through the observation points 16a and 16b shown in FIG. 4 is observed, the redundant monitoring eliminator 126 deals with the count of external abnormal flows F4 and F5, FIG. 3, passing through the observation point's 16a and 16b as the number of normal flows so as to subtract a value “2” which is the number of those external abnormal flows from the number of the overlapping external abnormal flows on the links 32 and 36 connecting the observation points 16a and 16b, a value “2”. Consequently, the values of overlap numbers of the links 32 and 36 for external abnormal flows become “0” as shown in FIG. 16.

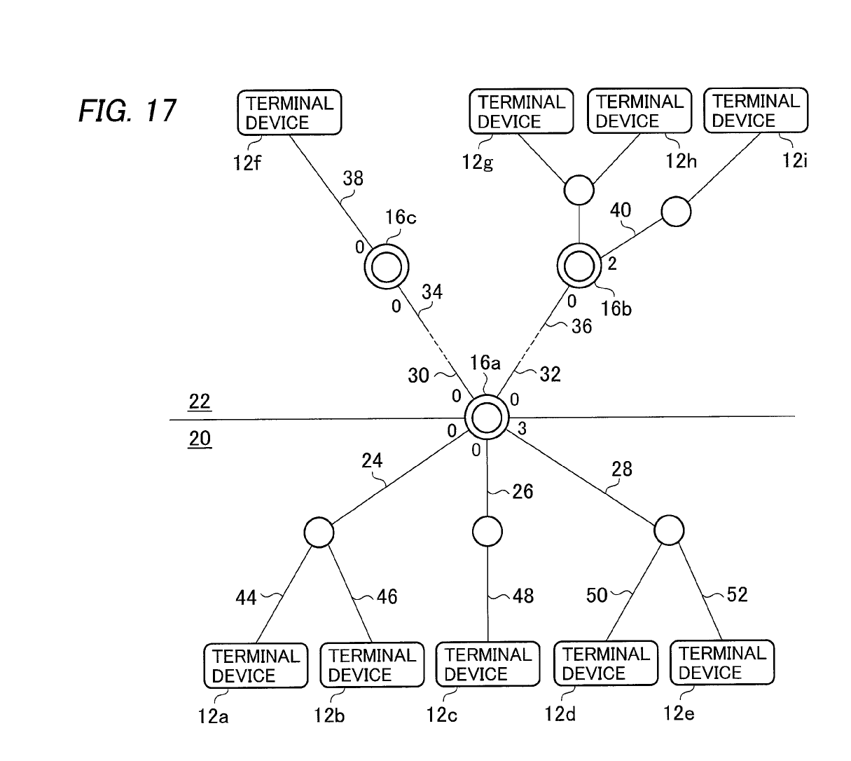

The adder 128, FIG. 9, of the overlap counter 116 in turn aggregates the numbers of overlapping internal abnormal flows on the links shown in FIG. 14 correspondingly to the numbers of overlapping external abnormal flows on the respective links shown in FIG. 16, and thereby the aggregation result shown in FIG. 17 will be obtained.

The operation of the anomaly locating device 18 then goes to step S12, FIG. 11, to determine the link largest in overlap number. As can be seen from FIG. 17, the link 28 has the maximum overlap number of value “3”, so that the maximum link determiner 118 determines the link 8 as the link having the largest overlap number. Since the link 28 passes the abnormal flows F1, F2 and F9, FIG. 3, the link candidate collector 120 in turn determines as link candidates, or collects information on, the links up to the terminal device on which the flows F1, F2 and F9 carried over the link 28 will terminate.

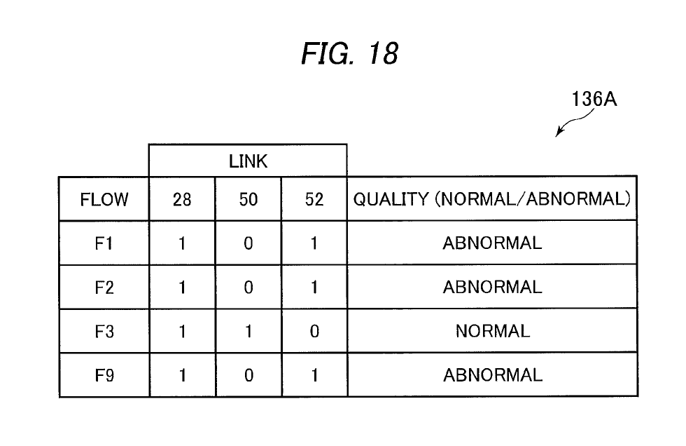

The anomaly link identifier 96 lists up the link candidates thus collected into a flow link correspondence table 136A as shown in FIG. 18. According to FIG. 18, the flow link correspondence table 136A contains a link candidate 52, which conveys the abnormal flows that are equal in number to or more than the flows on the link 40 having the second largest value “2” of overlap number in the table shown in FIG. 17. Thus, the anomaly link identifier 96 narrows down the link 52 to an anomaly link. Based on the identification result, the overlap counter 116 changes the value of overlap number of the link 28 from “3” to “0”. The remaining links 24, 26, 30, 34 and 38 where the abnormal flows F1, F2 and F9 pass have the overlap numbers thereof already decremented to a value “0” through the process of calculating the number of overlapping abnormal flows, and therefore a further subtraction will not be conducted.

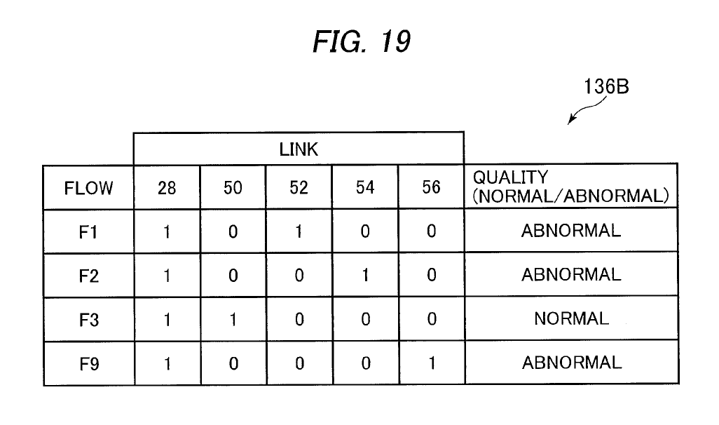

If another flow link correspondence table 136B shown in FIG. 19 is produced, the table 136B will not contain a link candidate conveying abnormal flows equal in number to or more than the flows on the link 40 having the second largest value “2” of the overlap number. In this case, the overlap counter 116 updates the overlap number of the link 28 to a value “1”, which is equal to the maximum number of abnormal flows passing on such a link that conveys the maximum number of abnormal flows in the flow link correspondence table 136B.

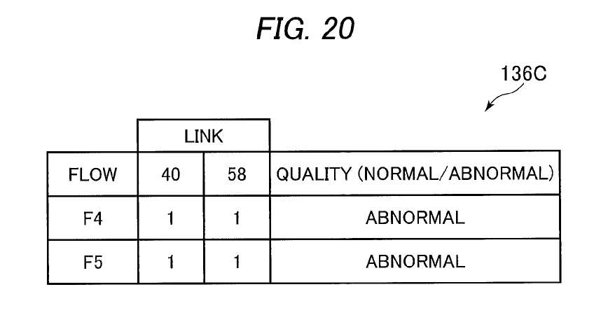

After the subroutine SUB1 of calculating the number of overlapping abnormal flows is completed, the control will proceed to the first cycle on the processing loop shown in FIG. 10, namely, the step S12 of determining a link having the largest overlap number through the step S18 of recalculating the overlap numbers. In the zero determination step S20, if it is determined that the processing loop has not been proceeded to on the overlap numbers of all links, i.e. the answer of the step shows “false” or “NO”, then a further, or second, cycle will be carried out on the processing loop. Among the currently remaining links, the link having the maximum overlap number, i.e. the current maximum link, is the link 40, in this example. The second cycle will therefore determine the link 40 as the largest overlap number. Then, a flow link correspondence table 136C shown in FIG. 20 is produced in the above-described manner. The anomaly link identifier 96 consults with the produced flow link correspondence table 136C to thereby narrow down a link 58 to an anomaly link to update the overlap number of the link 58 to a value “0”. Consequently, in this example, the values of the numbers of the overlapping abnormal flows on the links connected to all observation points have become “0”. Asa result, the step S20 of determining zero on the overlap numbers of all links turns out to be “true”, so that the monitoring operation based on locating an anomaly link will be terminated.

In summary, with the illustrative embodiment, a range of link candidates among which an anomaly link is to be estimated is refined or limited, and then from the limited link candidates, for example, a flow link correspondence table is formed to narrow down a possible anomaly link or links. Thus, the illustrative embodiment can minimize the memory capacity and operational burden for narrowing down the range of determining anomaly links.

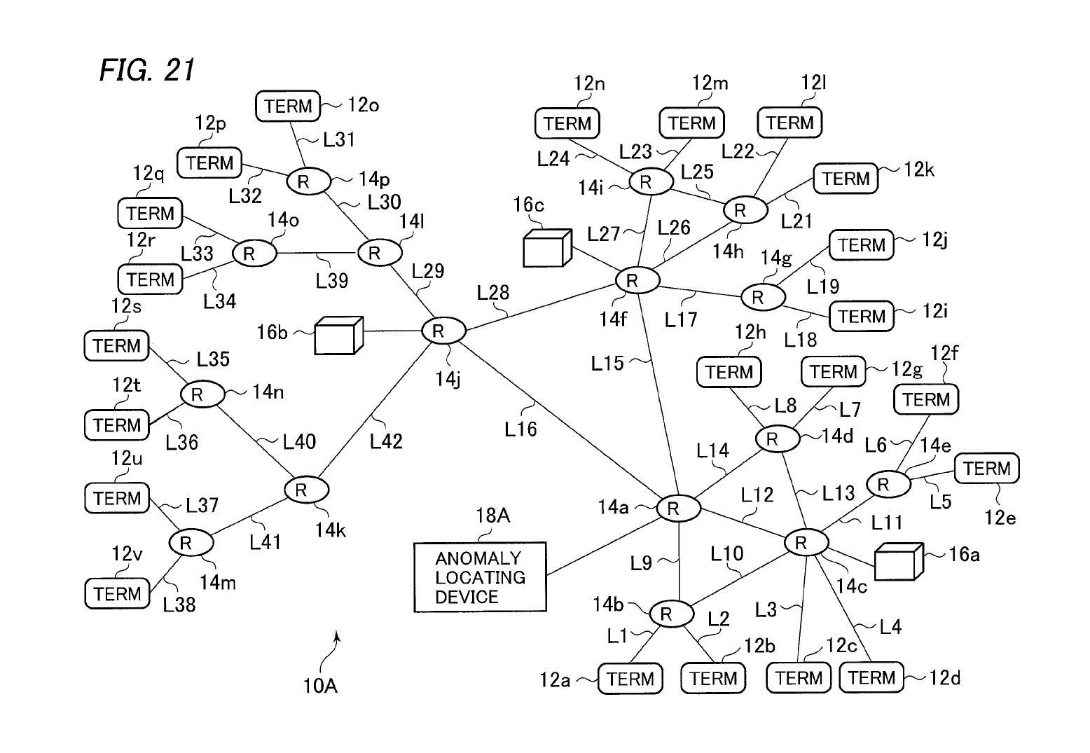

Now, with reference to FIG. 21, a description will be made on the schematic configuration of an anomaly identifying system 10A according to an alternative embodiment of the present invention. The anomaly identifying system 10A includes terminal devices 12a to 12v, routers 14a to 14p, observation nodes 16a to 16c and an anomaly locating device 18A. The routers 14a to 14p may be referred to as switches. These constituent elements are interconnected by a plurality of links, the links being denoted with reference numerals L1 to L42.

The observation nodes 16a, 16b and 16c are located at observation points on some networks and adapted to monitor data traffic passing through the observation points to thereby supply the anomaly locating device 18A with flow information resulting from the traffic monitoring. The observation nodes 16a, 16b and 16c are arranged in place as shown in FIG. 21 so as to respectively be connected to the routers 14c, 14j and 14f, by way of example.

The anomaly locating device 18A of this alternative embodiment also collects the flow information from the observation nodes 16a to 16c to narrow it down to an anomaly link on the network based on the collected flow information. As with the earlier-described embodiment, the anomaly locating device 18A can limit or refine a range of link candidates among which an anomaly link or links are to be estimated, and then from the link candidates thus limited, for example, a flow link correspondence table can be formed to narrow down the range to an anomaly link or links.

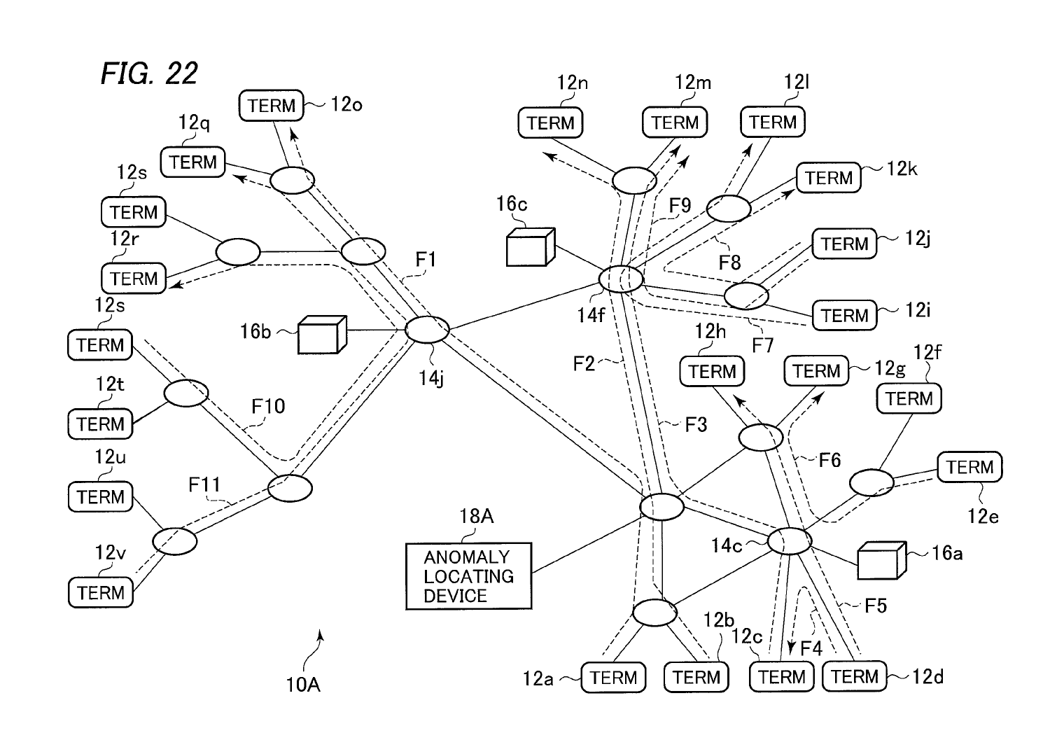

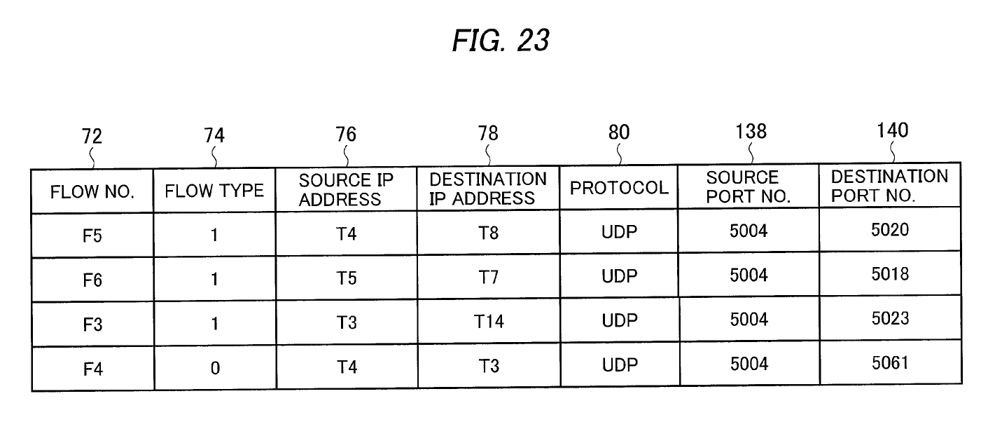

In the following, a specific example of flow information transmitted from the observation nodes 16a, 16b and 16c to the anomaly locating device 18A will be described by referring to FIGS. 22 to 25. As shown in FIG. 22, there are eleven flows F1 to F11 conveyed across the network 10A. In this case, the observation nodes 16a, 16b and 16c send the flow information shown in FIGS. 23, 24 and 25 to the anomaly locating device 18A. In FIG. 22, the terminal devices 12a to 12v are given own IP addresses respectively indicated with reference codes T1 to T22 in the boxes representing the devices.

FIG. 23 illustrates in a list form the breakdown of the flow information transmitted from the observation node 16a to the anomaly locating device 18A. As shown in FIGS. 22 and 23, the observation node 16a monitors the flows F3 to F6, which pass through the observation points, to supply the information on the flows F3 to F6 to the anomaly locating device 18A. The flow information shown in FIG. 23 includes a source port number 138 and a destination port number 140 as well as the flow number 72, the flow type 74, the source IP address 76, the destination IP address 78 and the protocol 80 shown in FIG. 5.

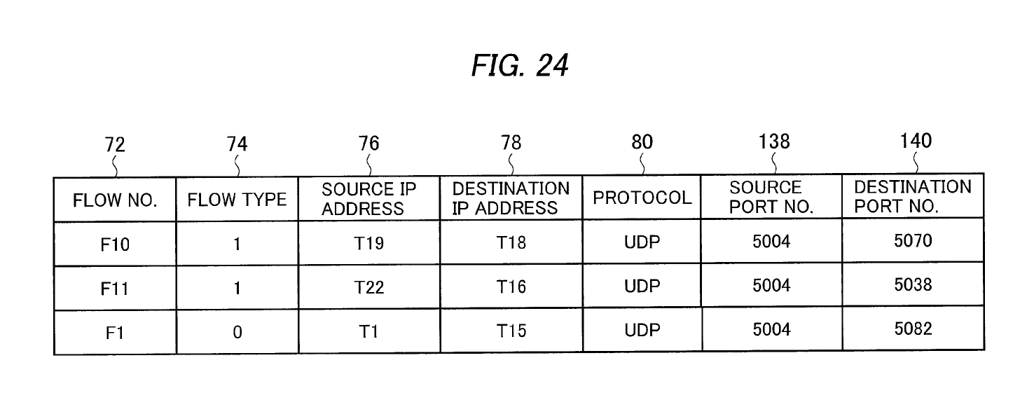

FIG. 24 shows in a list form the breakdown of the flow information transmitted from the observation node 16b to the anomaly locating device 18A. As is clear from FIG. 22, the observation node 16b monitors the flows F1, F10 and F11 passing through the observation point to send the information on the flows F1, F10 and F11 to the anomaly locating device 18A. The flow information from the observation node 16b also includes the items listed in FIG. 23.

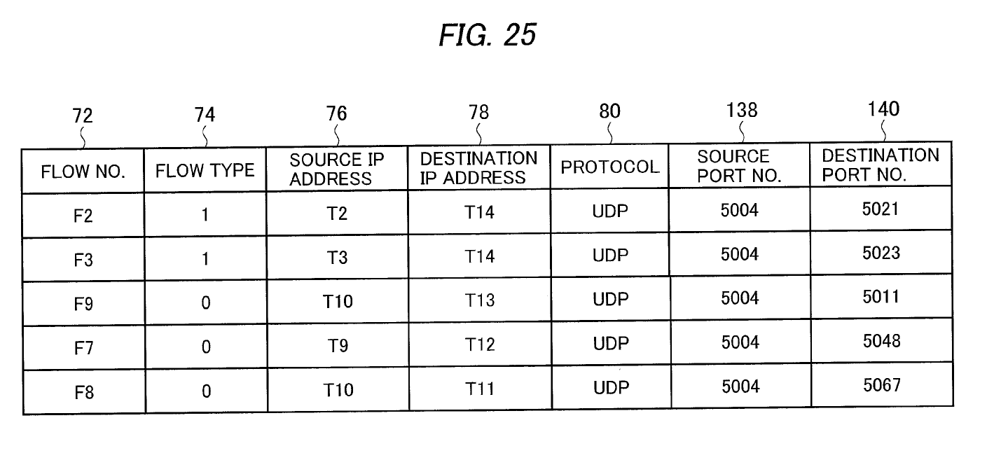

FIG. 25 shows in a list the breakdown of the flow information sent from the observation node 16c to the anomaly locating device 18A. As can be seen from FIG. 22, the observation node 16c monitors five flows F2, F3, F7, F8 and F9, which pass through the observation point, and supplies the information about the flows F2, F3, F7, F8 and F9 to the anomaly locating device 18A.

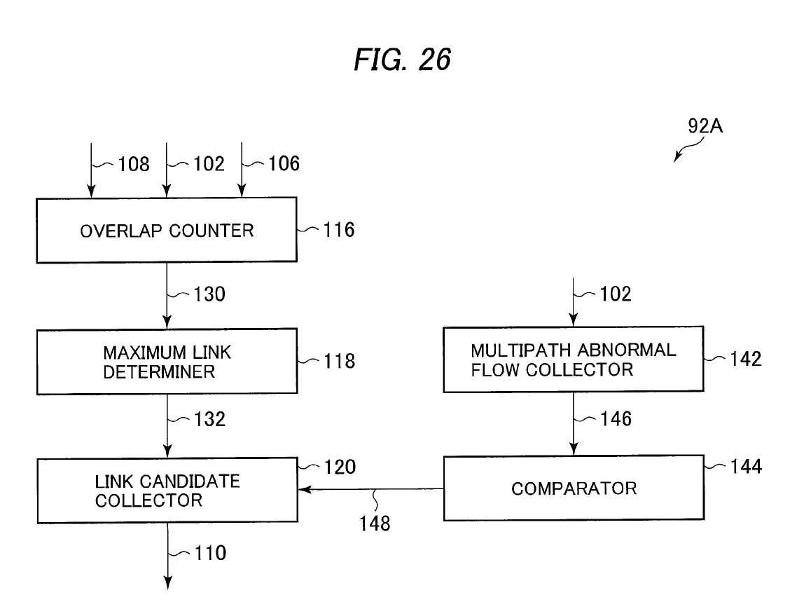

The anomaly locating device 18A of the alternative embodiment also includes the same constituent elements as the locating device 18 of the earlier-described embodiment shown in FIG. 8. The anomaly locating device 18A of the instant alternative embodiment may, however, be the same as the anomaly locating device 18 except for an anomaly location narrow-downer 92A, FIG. 26, including a multipath abnormal flow collector 142 and a comparator 144 in addition to the constituent elements of the anomaly location narrow-downer 92 of the earlier-described embodiment.

As briefly described above and also illustrated in FIG. 26, the anomaly location narrow-downer 92A has not only the overlap counter 116, the maximum link determiner 118 and the link candidate collector 120 but also the multipath abnormal flow collector 142 and the comparator 144. The multipath abnormal flow collector 142 has a function of using the flow information to detect, or collect information on, an abnormal flow or flows which pass through a plurality of observation points. The collector 142 supplies the comparator 144 with the number of abnormal flows 146 detected at each observation point passing the abnormal flows and thus determined from the collected flow information 102.

The comparator 144 is adapted to compare the total numbers of the abnormal flows detected as passing a couple of monitored observation points with each other, and use a result from the comparison to set as link candidates 148 such links that lead to a terminal device and other observation points which are reachable over a connecting link from a router having a smaller total number of detected abnormal flows to another router having a larger total number of detected abnormal flows. The comparator 144 supplies the set link candidates 148 to the link candidate collector 120. In other words, the comparator 144 may be considered to exclude from the link candidates a link reachable from the router having a smaller total number of abnormal flows via a link or links other than the connecting link.

The link candidate collector 120 is configured to collect link candidates to store them in the narrow-down information memory 94, and add or delete a collected link candidate to or from the narrow-down information memory 94 based on the comparison result 148. The link candidate collector 120 supplies the link candidate 110 to the narrow-down information memory 94 as the output of the anomaly location narrow-downer 92A. The narrow-down information memory 94 in turn outputs the data 112 contained in the created flow link correspondence table to the anomaly link identifier 96.

The anomaly link identifier 96 may be adapted to use the flow link correspondence table through the method of determining the minimum number of links, as described in respect of the previous embodiment, to thereby narrow down the range of locating anomalies to an abnormal link. The determination result is supplied as, for instance, information on abnormality via the output port 98 to the terminal devices in the network.

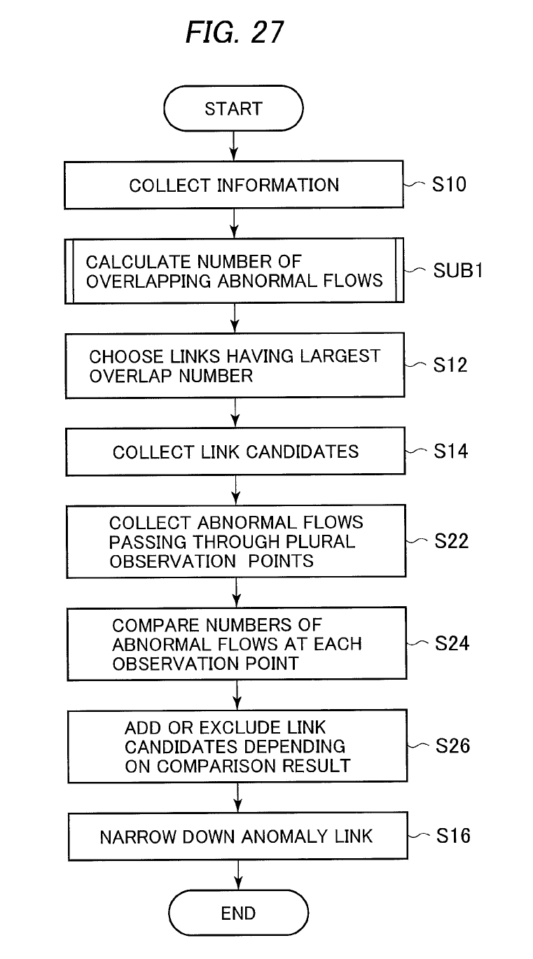

Next, the operation steps of the anomaly locating device 18A will briefly be described by referring to FIG. 27. Firstly, the anomaly locating device 18A carries out some processes as in the case of the earlier-described embodiment. More specifically, the flow information and the topology/routing information are collected (step S10). Then, the overlap counter 116 counts the number of abnormal flows passing on the links connected to each observation point to form an overlap number (subroutine SUB1). The maximum link determiner 118 in turn selectively determines a link being largest in number of overlapping abnormal flows from among the links connected to the observation points (step S12).

When a single link is solely determined as the link having the largest overlap number, the link candidate collector 120 refers to the routing information to thereby collect link candidates which are reachable via the link chosen by the maximum link determiner 118 (step S14). Unless the determining device 118 determines a single link being largest in overlap number, the link candidate collector 120 collects link candidates corresponding to all links led to a terminal device or observation point reachable via a link which passes the abnormal flow of interest (step S14). The collected link candidates 110 are stored in the narrow-down information memory 94.

The multipath abnormal flow collector 142 in turn collects information on abnormal flows passing through a plurality of observation points on the basis of the flow information 102 (step S22). Then the collector 142 outputs the number of the collected abnormal flows detected at each observation point to the comparator 144.

The comparator 144 compares the total numbers of the abnormal flows detected as passing a couple of observation points with each other (step S24). Based on a comparison result, the comparator 144 further collects as a link candidate a link reachable from a connecting link leading from an observation point having a smaller total number of abnormal flows to another observation point having a larger total number of abnormal flows, by way of example. The comparator 144 excludes from the link candidates a link reachable from the observation point having the smaller total number of abnormal flows via a link or links other than the connecting link.

Then, the link candidate collector 120 adds or deletes a link candidate to or from the narrow-down information memory 94 according to the result of the comparison made by the comparator 144 (step S26).

The anomaly link identifier 96 uses the link candidates stored in the narrow-down information memory 94 to create a flow link correspondence table, and then carrying out the method of determining the minimum number of links on the flow link correspondence table to thereby narrow down the range of locating anomalies to an abnormal link or links (step S20). After the determination step, the operation may, for instance, be terminated.

In the following, an illustrative procedure in the anomaly locating device 18A of the alternative embodiment will be described. This procedure is directed to the anomaly locating device 18A when data flows are conveyed across the network 10A shown in FIG. 22.

The overlap counter 116 refers to the topology/routing information memory 88, and recognizes that the router R3 which is the observation point of an observation node 16a has the links L3, L4, L10, L11, L12 and L13 connected thereto. The overlap counter 116 then collects from the flow information memory 84 the information on the abnormal flows observed at this observation point and references the topology/routing information memory 88 to thereby determine links that each abnormal flow goes through. In this way, various pieces of information are collected (step S10).

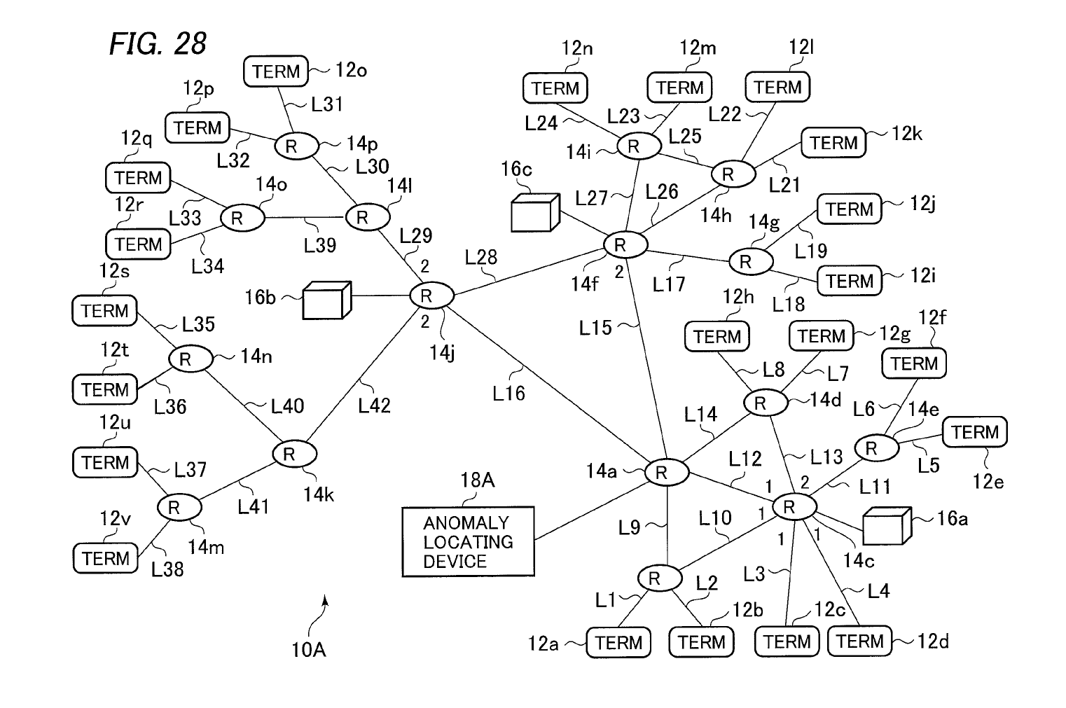

In this alternative embodiment, some data flows exist as illustrated in FIG. 22. Those flows include the flows F3, F5 and F6 as abnormal flows. Specifically, as clear from FIGS. 21 and 22, the abnormal flow F5 passes across the links L4 and L13, the abnormal flow F6 passes cross the links L11 and L13, and the abnormal flow F3 passes across the links L3 and L12. Thus, the overlap counter 116 counts the overlap numbers of the links L3, L4, L11 and L12 to values “1” and the overlap number of the link L13 to a value “2”, as shown in FIG. 28 (subroutine SUB1).

More specifically describing the counting processing, since the link L3 conducts the flows F3 and F4, of which the flow F3 is an abnormal flow, the count of the overlap number is “1”. Similarly, as the link L4 conducts the flows F4 and F5, of which only the flow F5 is an abnormal flow, the count of the overlap number is “1”. Furthermore, the links L11 and L12 pass only the respective flows F6 and F3, which are abnormal flows, so that the counts of the overlap numbers of the links L11 and L12 are “1”. As to the link L13, since the flows F5 and F6, which are abnormal flows, go thereon, the count of the overlap number is “2”.

Among the links L3, L4, L10, L11, L12 and L13, all of which are connected to the router (R) 14c serving as observation point, the maximum link determiner 118 selectively determines the link L3 having the largest number of overlapping abnormal flows (step S12).

The link candidate collector 120 collects from the topology/routing information memory 88 link candidates corresponding to all links appearing on a course routed to a terminal device reachable from the router 14c via the link L13, i.e. the links L7, L8 and L13 (step S14).

In regard to the observation node 16b, there exist the abnormal flows F10 and F11 passing through the router 14j, which pass over the link L29 via the link L42. As shown in FIG. 28, the link L29 conveys the flows F1, F10 and F11, two of which are abnormal flows, and thus the overlap counter 116 counts the overlap number of the link L29 to a value “2”. In addition to that, since the link L42 transfers the abnormal flows F10 and F11, the overlap counter 116 counts the overlap number of the link L42 to a value “2”. Consequently, the maximum link determiner 118 determines both of the links L29 and L42 as links having the largest overlap number. Therefore, the link candidate collector 120 collects link candidates corresponding to all links involved in the course routed to a terminal device or another observation point reachable from the router 14j over the link L29 or L42, i.e. the links L29 through L42.

In the case where a plurality of abnormal flows pass links combined with each other, the overlap counter 116 does not need to count more than one abnormal flow. For example, since the abnormal flows F10 and F11 pass the links L29 and L42 that are in combination with each other with respect to the router 14j, the overlap counter 116 may count the overlap numbers of the links L29 and L42 to a value of “1”.

Concerning the observation node 16c, among the flows F2, F3, F7, F8 and F9 which pass through the router 14f, the flows F2 and F3 are defined as abnormal flows, by way of example. In this case, as two abnormal flows F2 and F3 are conveyed over the links L15 and L27, the overlap counter 116 counts separately the numbers of overlapping abnormal flows of the links L15 and L27 to values “2”, as shown in FIG. 28. Thus, the maximum link determiner 118 determines that both of the links L15 and L27 are links having the largest overlap number. As a consequence, the link candidate collector 120 collects link candidates corresponding to all the links involved in the course routed to a terminal device or another observation point reachable from the router 14f over the link L15 or L27, i.e. the links L1, L2, L7, L8, L9, L12 and L14 which are reachable via the link 15 as well as the links L23 and L24 reachable via the link L27.

Subsequently, the multipath abnormal flow collector 142 collects information on the abnormal flow F3, which passes through the observation point 14c in the observation node 16a and the observation point 14f in the observation node 16c (step S22).

The comparator 144 compares the total number of abnormal flows detected in the router 14c with the total number of abnormal flows detected in the router 14f (step S24). As a result, the total number of abnormal flows in the router 14c is three, and the total number in the router 14f is two. That is, the total number of abnormal flows in the router R6 is smaller than that of the router R3. Consequently, the link candidate collector 120 is responsive to the comparator 144, collects link candidates corresponding to links involved in the routes to terminal devices and other observation points reachable from the connecting link L15 from the router 14f to the router 14c (step S26). More specifically, the link candidates are the links L1, L2, L7, L8, L9, L12, L14 and L15. The link candidate collector 120 then deletes from the link candidates the links on the course routed to the terminal device or other observation point reachable from the links L17 and L27, namely the links L23, L24 and L27 already collected (step S26).

The above processes have thus caused the narrow-down information memory 94 to store link candidates corresponding to the links L1, L2, L7, L8, L9, L12, L13, L14 and L15 as well as the links L29 to L42.

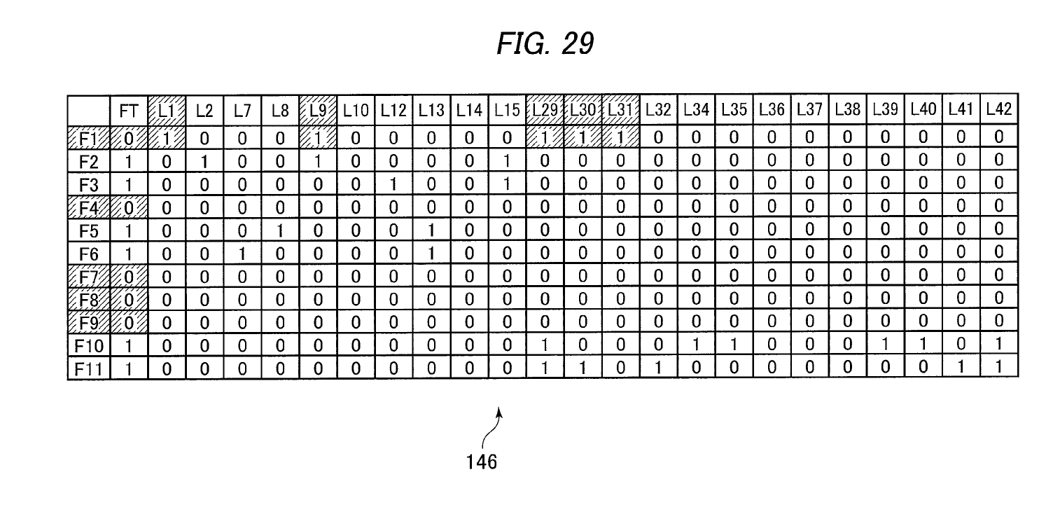

The anomaly link identifier 96 uses the link candidates thus stored to generate a flow link correspondence table 146 illustrated in FIG. 29. The table 146 shows links in its columns while showing abnormal flows in its rows in such a way as to represent the links conveying abnormal flows as binary values “1” and the links conveying normal flows as binary values “0”. In the figure, the normal flows are the flows F1, F4, F7, F8 and F9 indicated by hatching and the FT values thereof are represented as a value “0”. In the row of the normal flow F1 in the figure, the links L1, L9, L29, L30 and L31 in FIG. 29 pass abnormal flows, and are therefore indicated by hatching and represented by binary values “1”.

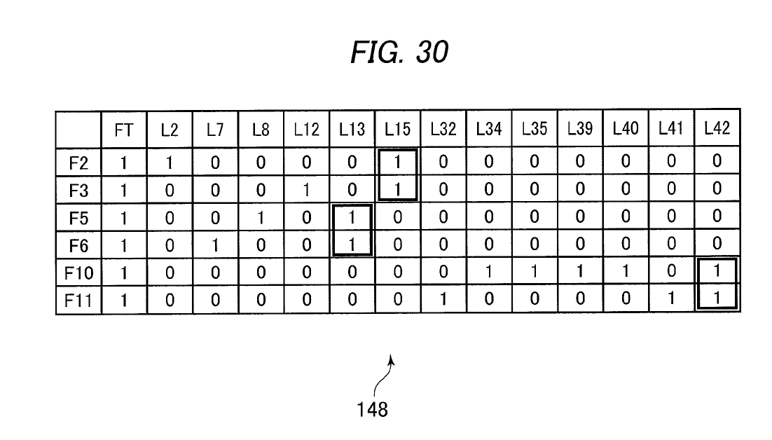

The anomaly link identifier 96 then deletes from the flow link correspondence table 146 shown in FIG. 29 the links passing the normal flows and the links passing no flows. As a result, a flow link correspondence table 148 shown in FIG. 30 will be obtained. The anomaly link identifier 96 applies the method for determining the minimum number of links to the flow link correspondence table 148 shown in FIG. 30 to thereby find out that a plurality of abnormal flows pass through one and the same link to determine these links as faulty or anomalous. The identifier 96 can determine the links L13, L15 and L42, each enclosed in a box of thick full lines shown in FIG. 30, as abnormal links (step S20).

In short, according to the alternative embodiment, a range of link candidates among which an anomaly link is to be estimated is refined, and then from the refined link candidates, for example, a flow link correspondence table is formed to estimate an anomaly link or links. Thus, the present invention can minimize the memory capacity, operational burden and costs for narrowing links down to anomaly links.

The present invention has been described with reference to the particular illustrative embodiments, but is not to be restricted by the embodiments. It is to be appreciated that those skilled in the art can change or modify the embodiments without departing from the scope and spirit of the present invention.

For example, the above-described steps of the operation of the anomaly locating device 18 or 18A may not necessarily be carried out in chronological order given in the flowcharts. Alternatively, each step can be performed in a different order or even in parallel, by way of example.

Furthermore, any computer programs can be designed to control the hardware, e.g. the CPU, ROM and RAM, installed in the anomaly locating device 18 or 18A so as to function as the constituent elements of the device 18 or 18A. In addition, storage media for storing such programs may be provided.

The entire disclosure of Japanese patent application No. 2011-45518 filed on Mar. 2, 2011, including the specification, claims, accompanying drawings and abstract of the disclosure, is incorporated herein by reference in its entirety.

What is claimed is:

1. An anomaly locating device for use in a telecommunications network formed by a plurality of nodes connected by links conveying flows between terminal devices, wherein the plurality of nodes include an observation node arranged at an observation point, said device comprising:
a flow information collector collecting flow information on the flows between the terminal devices from the observation node;
an anomaly location narrow-downer counting an overlap number of overlapping abnormal flows passing through the links connected to the observation point on a basis of the flow information, and determining such one of the links connected to the observation point that is largest in the overlap number, said anomaly location narrow-downer collecting a link candidate reachable by routing via the one link determined; and
an anomaly link identifier narrowing down the collected link candidates to an anomaly link malfunctioning,
said anomaly location narrow-downer comprising:
a counter counting the overlap number;
a determiner determining the one link being largest in the overlap number; and
a link candidate collector collecting a link candidate reachable by routing via the determined one link.

2. The device in accordance with claim 1, wherein, when said determiner determines the one links in plural as being largest in the overlap number, said link candidate collector collects a link candidate reachable via the link passing abnormal flows among the links connected to the observation point.

3. The device in accordance with claim 1, wherein the network includes the observation nodes in plural arranged at the observation points in plural,
said flow information collector collecting the flow information from the plurality of observation nodes,
said counter, said link candidate collector and said anomaly link identifier narrowing down the links connected to the plurality of observation points.

4. The device in accordance with claim 3, wherein, when a normal flow is observed as associated with at least one of the terminal devices associated with the abnormal flow, said counter subtracts the number of the overlapping abnormal flows output from the at least one terminal device from the number of the overlapping abnormal flows passing through the link on a side of the at least one terminal device.

5. The device in accordance with claim 3, wherein the network includes an internal network including the link from one of the observation points to a terminal device reachable without passing another of the observation points, and an external network including a link from the one observation point to the other observation point,
the network carrying an external flow through the external network and an internal flow through the internal network,
said counter subtracting, when a normal flow is observed in the internal flow as associated with at least one of the terminal devices associated with an internal abnormal flow malfunctioning, a number of internal abnormal flows output from the at least one terminal device from the number of the overlapping internal abnormal flows passing over the link on a side of the terminal device connected to the one observation point.

6. The device in accordance with claim 5, wherein, when a normal flow is observed in the external flow as associated with least one of the terminal devices associated with an external abnormal flow malfunctioning, said counter subtracts the number of external abnormal flows output from the at least one terminal device from the number of the overlapping abnormal flows on one of the links which pass the normal flow and exclude a link on the side of another of the terminal devices which is connected to the one observation point and passes the external abnormal flow.

7. The device in accordance with claim 6, wherein, when an external normal flow is observed as passing through the one observation point and the other observation point, said counter subtracts the number of abnormal flows passing through the one and the other observation point from the number of overlapping abnormal flows on the link on the side of the other observation point connected to the one observation point.

8. The device in accordance with claim 7, wherein said anomaly link identifier creates a correspondence table listing the link candidate collected by said link candidate collector as well as the abnormal and normal flows that pass over the link candidates,
said anomaly link identifier eliminating from the correspondence table the link candidates passing the normal flow,
said anomaly link identifier determining the anomaly link on the basis of the number of abnormal flows passing over the link candidate remaining in the correspondence table.

9. The device in accordance with claim 8, wherein, when a link candidate largest in the number of passing abnormal flows is listed in the correspondence table and the number of abnormal flows passing over the link candidate is second largest or more in the numbers of overlapping abnormal flows among all links connected to the plurality of observation points, said anomaly link identifier narrows down the link candidate to the anomaly link.

10. The device in accordance with claim 3, wherein the observation nodes are arranged in observation points at gateways of the network.

11. The device in accordance with claim 3, wherein said anomaly link identifier comprises:
an abnormal flow collector collecting information on an abnormal flow passing through two or more of the observation points; and
a comparator comparing a total number of the abnormal flows based on the information collected by said abnormal flow collector,
said link candidate collector further collecting a link candidate corresponding to a link reachable from a connecting link leading from an observation point having a smaller total number of abnormal flows to another observation point having a larger total number of abnormal flows, and eliminating from the link candidates a link reachable from the observation point having the smaller total number of abnormal flows via a link other than the connecting link.

12. The device in accordance with claim 11, wherein, when plural abnormal flows pass on a same link connected to the observation point, said counter counts the plural abnormal flows to single.

13. A method for determining an anomaly link in a telecommunications network formed by a plurality of nodes connected by links conveying flows between terminal devices, wherein the plurality of nodes include an observation node arranged at an observation point, said method comprising:
collecting flow information on the flows between the terminal devices from the observation nodes by a flow information collector collecting the flow information;
counting based on the flow information an overlap number of overlapping abnormal flows passing through the links connected to the observation point by a counter of an anomaly location narrow-downer counting the number of the overlapping abnormal flows;
determining such one of the links connected to the observation point that is largest in the overlap number by a determiner of an anomaly location narrow-downer determining the one link;
collecting a link candidate reachable by routing via the determined one link by a link candidate collector of the anomaly location narrow-downer collecting the link candidate reachable; and
narrowing down the collected link candidates to an anomaly link malfunctioning by an anomaly link identifier determining the anomaly link.

14. A storage medium storing a program for use in a telecommunications network formed by a plurality of nodes connected by links conveying flows between terminal devices, wherein the plurality of nodes include an observation node arranged at an observation point, the program causing a computer, when having the program installed and run, to serve as:
a flow information collector collecting flow information on the flows between the terminal devices from the observation node;
an anomaly location narrow-downer counting an overlap number of overlapping abnormal flows passing through the links connected to the observation point on a basis of the flow information, and determining such one of the links connected to the observation point that is largest in the overlap number, said anomaly location narrow-downer collecting a link candidate reachable by routing via the one link determined; and
an anomaly link identifier narrowing down the collected link candidates to an anomaly link malfunctioning,
said anomaly location narrow-downer further serving as a counter counting the overlap number, a determiner determining the one link being largest in the overlap number, and a link candidate collector collecting a link candidate reachable by routing via the determined one link.

15. An anomaly link identifying system in a telecommunications network formed by a plurality of nodes connected by links conveying flows between terminal devices, said system comprising:
an observation node included in the plurality of nodes and arranged at an observation point; and
an anomaly link identification device which is supplied with flow information on the flows observed at the observation node,
said anomaly link identification device comprising:
a flow information collector collecting the flow information from the observation node;
an anomaly location narrow-downer counting an overlap number of overlapping abnormal flows passing through the links connected to the observation point on a basis of the flow information, and determining such one of the links connected to the observation point that is largest in the overlap number, said anomaly location narrow-downer collecting a link candidate reachable by routing via the one link determined; and
an anomaly link identifier narrowing down the collected link candidates to an anomaly link malfunctioning,
said anomaly location narrow-downer comprising:
a counter counting the overlap number;
a determiner determining the one link being largest in the overlap number; and
a link candidate collector collecting a link candidate reachable by routing via the determined one link.
